(19) United States
(12) Patent Application Publication
(10) Pub. No.: US 2013/0024421 A1
(43) Pub. Date: Jan. 24, 2013

(54) FILE STORAGE SYSTEM FOR TRANSFERRING FILE TO REMOTE ARCHIVE SYSTEM

(71) Applicant: Tomohiro Shinohara, Odawara (JP)

(72) Inventor: Tomohiro Shinohara, Odawara (JP)

(73) Assignee: Hitachi, Ltd.

(21) Appl. No.: 13/147,494

(22) PCT Filed: Jul. 22, 2011
(86) PCT No.: PCT/JP11/04140

§ 371 Date: Aug. 2, 2011

(51) Int. Cl. G06F 17/30

(52) U.S. Cl. 707/622; 707/E17.01

(57) ABSTRACT

An archive system and a file storage system are connected via a communication network, wherein the file storage system (a) replicates a file to the archive system; (b) manages the replicated file as a file to be stubbed; (c) updates the priority information of a metadata based on a result computed from the priority information of metadata of an already stored file and the priority information of the access request; (d) retains an access date and time information of the access request in the metadata; (e) monitors a used capacity of the file storage system; and (f) starts a deleting process of a file to be stubbed using either the priority information or the date and time information in the metadata when the used capacity exceeds an upper limit set in advance.

### TECHNICAL FIELD

The present invention relates to the art of storage control that transfers and stores files via communication networks.

### BACKGROUND ART

Conventionally, storage systems composed of RAIDs (Redundant Arrays of Inexpensive Disks) in which multiple HDDs (Hard Disk Drives) are arranged in arrays for managing large amounts of data have been used.

These storage systems and host computers were mainly connected via block I/O interfaces such as FC (Fiber Channel) and SCSI (Small Computers System Interface) in which I/O are processed via block units.

The recent advancement in IT has lead to the development of inexpensive NAS (Network Attached Storage) file storage systems as disk array systems providing file services to clients by receiving file accesses from clients via the network. Typical examples of connection interface protocols of such systems are file I/O interfaces such as NFS (Network File Interface) and CIFS (Common Interface File System).

On the other hand, users such as companies and individuals have independently purchased hardware resources such as storage systems, servers and PC (Personal Computers) and software resources such as OS (Operating Systems) and AP (Application Software) to create their own systems.

However, the recent increase in the amount of data to be handled caused rapid rise of TCO (Total Cost of Ownership) of these systems, and the cutting down of costs has become an urgent task.

One method for solving this problem is the cloud computing system in which hardware and software resources are shared and used via communication networks such as the internet, and the use of such system is spreading widely. One example of use of such cloud computing system is disclosed in patent literature 1, which teaches using the system via the interne. The client must connect to the interne to use the cloud computing system.

Patent literature 2 discloses a prior art related to controlling the QoS (Quality of Service) of protocols from the viewpoint of user-friendliness (usability). The literature teaches a NAS storage system in which a priority set in a reply packet replied to the NAS client as an answer to a file access request for accessing a folder having a high level of importance is set higher than a priority set in the reply packet replied to the client as an answer to a file access request for accessing a folder having a low level of importance.

### CITATION LIST

### Patent Literature

PTL 1: Japanese Patent Application Laid-Open Publication No. 2009-110401(United States Patent Application Laid-Open Publication No. 2009-0125522)
PTL 2: Japanese Patent Application Laid-Open Publication No. 2007-310772(United States Patent Application Laid-Open Publication No. 2007-0271391)

### SUMMARY OF INVENTION

### Technical Problem

According to the prior art disclosed in the above-mentioned patent literature, the reading and writing of files from/to the cloud computing system must always be performed via the network. Therefore, there were delays in the data access and the access time was extended.

Therefore, as described, the files having high priority are stored in the NAS storage system while the files having low priority are stored in the cloud computing system. However, the capacity of files capable of being stored in the NAS storage system is limited. Therefore, if the used capacity exceeds a certain threshold, the files having relatively lower priority within the group of files having high priority must be transferred to the cloud computing system having a large capacity and deleted from the NAS storage system.

Further, if the client accesses a deleted file, the file must be rewritten into the NAS storage system from the cloud computing system. Therefore, the present invention aims at providing a file sharing service capable of answering to the needs of respective clients while preventing deterioration of performance of file accesses.

### Solution to Problem

In order to solve the prior art problems, the present invention provides a file storage system having a local file system and connected to a communication network to which an archive system having a remotely controlled remote file system is connected, comprising:

a first communication interface system connected to said communication network;

a second communication interface system connected to a second communication network connected to a client terminal through which a client enters an access request which is a write request or a read request of a file; and

a processor for controlling the first communication interface system and the second communication interface system,

wherein the processor
(a) replicates a file in the local file system to the remote file system;
(b) manages the replicated file as a file to be stubbed;
(c) sets a priority information included in the access request as a priority information of metadata for managing the file in the local file system if the access from the client terminal is a first request;
(d) updates the priority information of the metadata based on a result computed from the priority information of metadata of an already stored file and the priority information of the access request if the access from the client terminal is a second request;
(e) retains an access date and time information of the access request in the metadata;
(f) monitors a used capacity of the local file system; and
(g) starts a deleting process of a file to be stubbed in the local file system using either the priority information or the date and time information in the metadata when the used capacity exceeds an upper limit set in advance.

### Advantageous Effects of Invention

The priority information included in the network packets transmitted from the clients are used to determine the priority of files to be stubbed (by which the actual data in the local file system is deleted and only the management information thereof is maintained). Therefore, the files being accessed frequently from networks having high priority will have higher priority and will not be deleted easily.

Furthermore, the access date information is also used as the condition for determining whether to perform stubbing, so the files having low priority but are new will not be deleted easily. The present system enables to provide a high speed file access system and service capable of responding to the demands of clients.

### BRIEF DESCRIPTION OF DRAWINGS

FIG. 1 shows a hardware configuration of the whole system according to one preferred embodiment of the present invention.

FIG. 2 shows a software configuration of the whole system according to one preferred embodiment of the present invention.

FIG. 3 is a schematic view of the operation for controlling stubbing according to one preferred embodiment of the present invention.

FIG. 4 shows a functional configuration of the whole system according to one preferred embodiment of the present invention.

FIG. 5 shows a structure of a VLAN packet with a tag according to a VLAN function.

FIG. 6 shows the relationship between VLAN_ID and virtual I/F.

FIG. 7 shows the relationship between VLAN_ID and priority.

FIG. 8 is a flowchart showing the flow of process during reception according to the VLAN function.

FIG. 9 is a flowchart showing the flow of process during transmission according to the VLAN function.

FIG. 10 is a flowchart showing the flow of the priority identification process according to the VLAN function.

FIG. 11 shows the contents of received data analyzed via a file sharing function.

FIG. 12 shows the contents of transmitted data created via the file sharing function.

FIG. 13 shows the priority of respective file accesses.

FIG. 14 is a flowchart showing the flow of access request reception process according to the file sharing function.

FIG. 15 shows a file structure stored in the file system.

FIG. 16 shows the structure of metadata.

FIG. 17 shows a status transition table of files.

FIG. 18 shows a status transition diagram of files.

FIG. 19 shows an event notification table during file access.

FIG. 20 is a flowchart showing a priority determination process and a file access notification process when a new file creation request is received.

FIG. 21 is a flowchart showing a priority determination process and a file access notification process when a write request is received.

FIG. 22 is a flowchart showing a priority determination process and a file access notification process when a reference request is received.

FIG. 23 is a flowchart showing a priority determination process and a file access notification process when a delete request is received.

FIG. 24 is a flowchart showing the flow of process of a recall request according to a file system function.

FIG. 25 is a flowchart showing the flow of the recall process.

FIG. 26 shows the correspondence of events and recorded object list.

FIG. 27 shows a replication list.

FIG. 28 shows names of lists to be stubbed.

FIG. 29 is a flowchart showing the flow of a list creation process according to an archive function.

FIG. 30 shows a replication process contents table.

FIG. 31 is a flowchart showing the flow of a replication process according to the archive function.

FIG. 32 shows a table of contents of a stubbing process.

FIG. 33 is a correspondence table of stubbing methods and process contents.

FIG. 34 shows the order of stubbing process based on order of date.

FIG. 35 shows the order of the stubbing process based on order of priority.

FIG. 36 shows the order of the stubbing process based on a ratio of one to one.

FIG. 37 shows the order of the stubbing process based on a ratio of one to three.

FIG. 38 is a flowchart showing the flow of the overall stubbing process.

FIG. 39 is a flowchart showing the flow of metadata determination and redistribution process according to the stubbing process.

FIG. 40 shows a file writing operation to a file system according to the present invention.

FIG. 41 shows a replication and cashing operation according to the present invention.

FIG. 42 shows a writing operation of a new file to a file system according to the present invention.

FIG. 43 shows a stubbing operation according to the present invention.

FIG. 44 shows a reference operation to a stubbed file according to the present invention.

FIG. 45 shows a recall operation of a file according to the present invention.

FIG. 46 shows the outline of the stubbing operation according to the present invention.

### DESCRIPTION OF EMBODIMENTS

Now, the preferred embodiments of the present invention will be described with reference to the accompanied drawings.

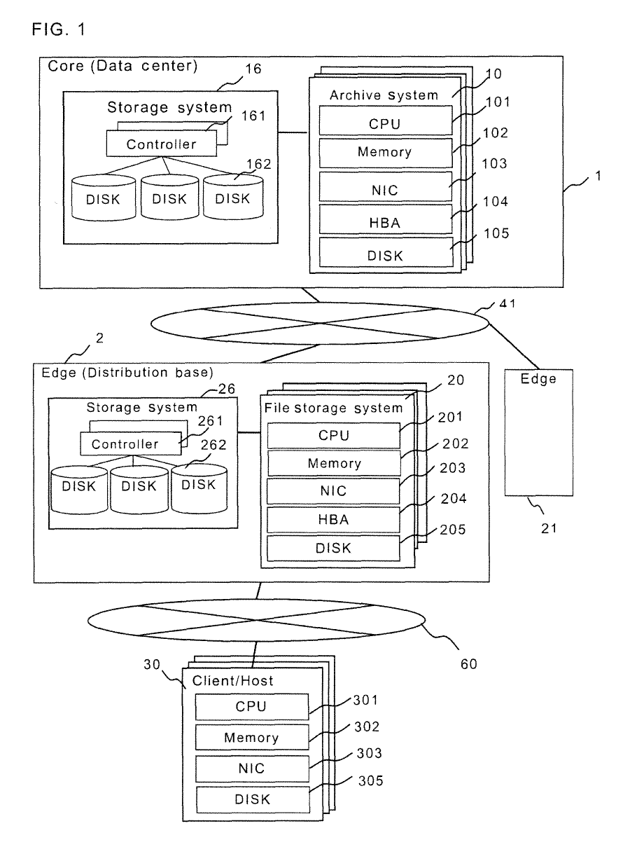

First, the overall outline of the present invention will be described with reference to FIGS. 1 through 3. FIG. 1 illustrates a hardware configuration of the overall system according to one preferred embodiment of the present invention. An archive system 10 includes a memory 102 for storing data and reading in programs such as OS for controlling the archive system. It also includes a CPU 101 for executing the programs. The memory 102 can be a RAM (Random Access Memory), a ROM (Read Only Memory), or a flash memory which is a rewritable nonvolatile memory.

The archive system communicates with a file storage system 20 connected thereto via a communication network (hereinafter referred to as network) 41 using an NIC (Network Interface Card) 103. The network can be either the internet using general public circuits or a LAN (Local Area Network).

The archive system is connected to a storage system 16 through an HBA (Host Bus Adapter) 104 and via a network (such as a SAN (Storage Area Network)), and performs accesses in units of blocks. The storage system 16 is composed of a controller 161 and disks 162. The disks 162 and 105 are disk-type memory devices (such as HDD (Hard Disk Drives)), but they can also be memory devices such as flash memories. The types of HDDs are selected according to use for example from FC, SAS (Serial Attached SCSI) and SATA (Serial ATA).

The storage system 16 receives an I/O request transmitted from the HBA 104 of the archive system 10. Upon receiving the I/O request, the controller 161 reads or writes (refers to) data from or to an appropriate disk 162. The archive system 10 and the storage system 16 constitute a core 1 acting as a collective base, such as a data center. It is also possible to adopt an arrangement in which the archive system is not connected to the storage system 16 (so that the core 1 is composed only of the archive system 10), and in that case, data is stored in the disks 105 of the archive system 10.

The file storage system 20 reads programs for controlling the whole system including the OS into a memory 202, and executes programs via a CPU 201.

Further, an NIC 203 performs communication between clients 30 and the archive system 10 connected via networks 41 and 60. The file storage system 20 is connected via an HBA 204 with the storage system 26 to access data. The storage system 26 receives an I/O request transmitted from the HBA 204 of the file storage system 20. Upon receiving the I/O request, a controller 261 writes data into or reads data from (refers to data in) an appropriate disk 262.

The file storage system 20 and the storage system 26 constitute a distribution base edge 2 as a remote office. Similar to the archive system 10, a configuration can be adopted in which the file storage system 20 is not connected to the storage system 26, and in that case, data is stored in the disks 205 of the file storage system 20.

The client 30 reads programs such as OS and AP (Application Programs) 310 stored in a disk 305 onto a memory 302, executes the program via a CPU 301, and controls the whole system. Further, the client performs communication via the network 60 with the file storage system 20 using an NIC303 in units of files. The disks 205, 262 and 305 adopt disk-type memory devices (HDD (Hard Disk Drives)), but they can also adopt memory devices such as flash memories. The types of HDDs are selected according to use for example from FC, SAS (Serial Attached SCSI) and SATA (Serial ATA).

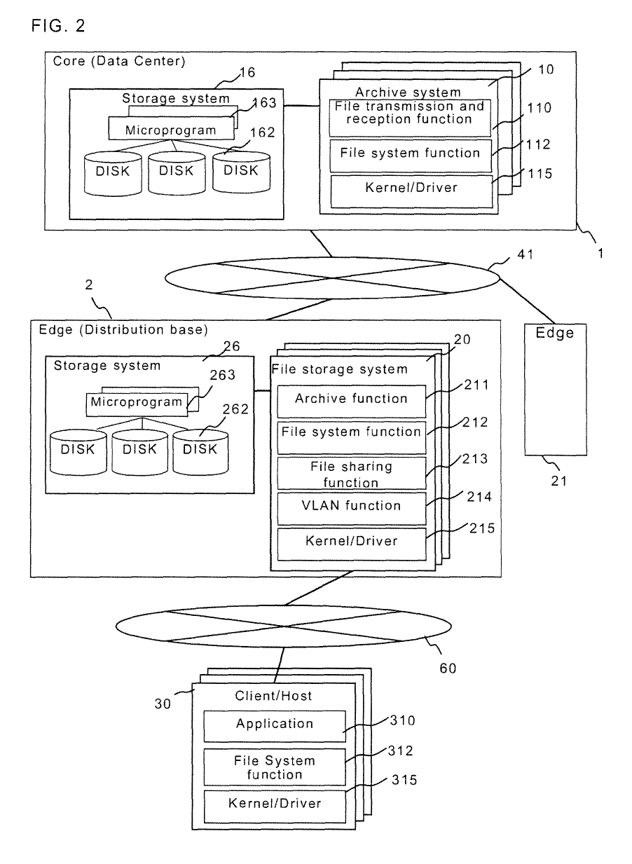

Next, the software configuration of the whole system will be described with reference to FIG. 2. Micro-programs 163 and 263 operating on controllers 161 and 261 in storage systems 16 and 26 are programs for performing control to distribute data received from the archive system 10 to disks 162. A file transmission and reception function program 110 is a program for receiving file data from an archive function program 211 of the file storage system 20 and storing the received data in the disk 105 of the archive system 10 or the disk 162 of the storage system 16.

Further, the file transmission and reception function program 110 is a program for reading data from the disk 105 of the archive system 10 or the disk 162 of the storage system 16 in response to a transfer request from the archive function program 211 and transferring the read data to the file storage system 20.

A file system function program 112 is a program that relates the physical management units of the disks with the logical management units as files. The file system function program 112 enables reading and writing of data in file units to the archive system 10. The file system function program 312 of the client 30 also has a similar function.

Kernel/drivers 115, 215 and 315 are programs for executing control operations specific to hardware, such as the schedule control of multiple programs operating on the archive system 10, the file storage system 20 and the client 30 or hardware interruption processes.

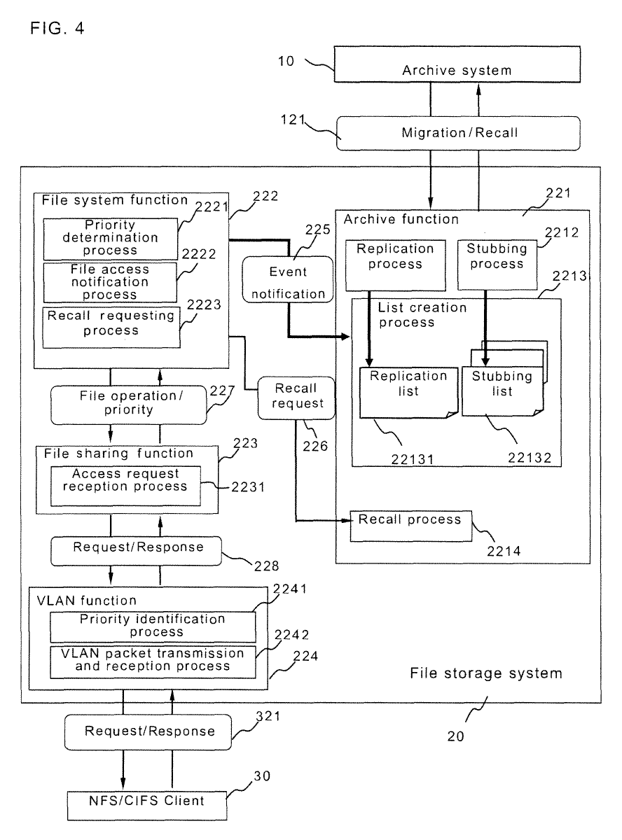

The file storage system 20 includes a file system function program 212, similar to the archive system 10. Other than performing data read/write control, the file system function program 212 has a function to execute a priority determination process 2221, a file access notification process 2222 and a recall process 2223 which are characteristic to the present invention as shown in FIG. 4.

A file sharing function program 213 is a program capable of enabling the client 30 to access files on the file storage system 20 via the network 60, and is equipped with an access request reception process function 2241 which is characteristic to the present invention. The file sharing function program 213 enables files to be shared among multiple clients.

A VLAN function program 214 is a function program for dividing a physical network 60 into virtual networks, and is equipped with a priority identification process function which is characteristic to the present invention.

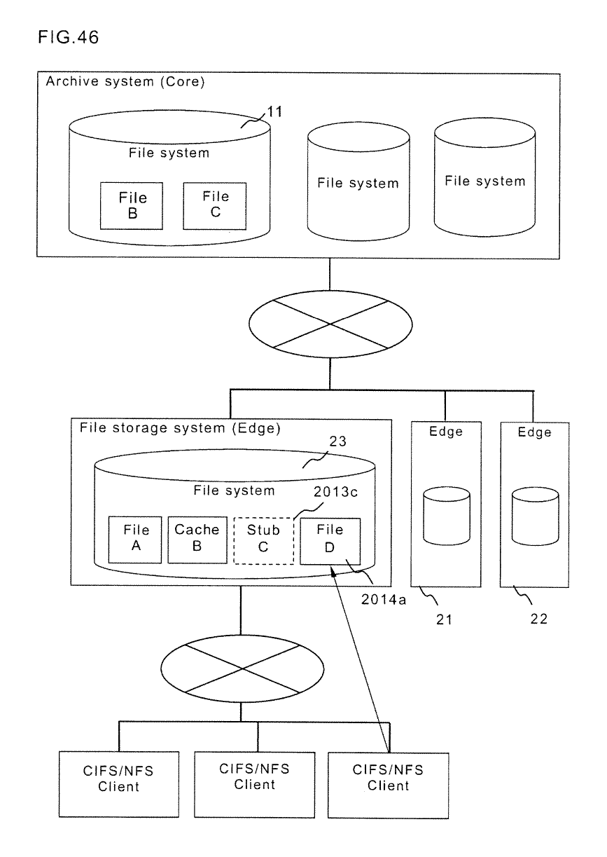

The archive function program 211 is equipped with a replication process function 2211 for copying the files in the file storage system 20 to the archive system 10, and a stubbing (actual data of a file in the edge 2 is deleted and only the management information thereof is retained as shown in FIG. 46) function 2212.

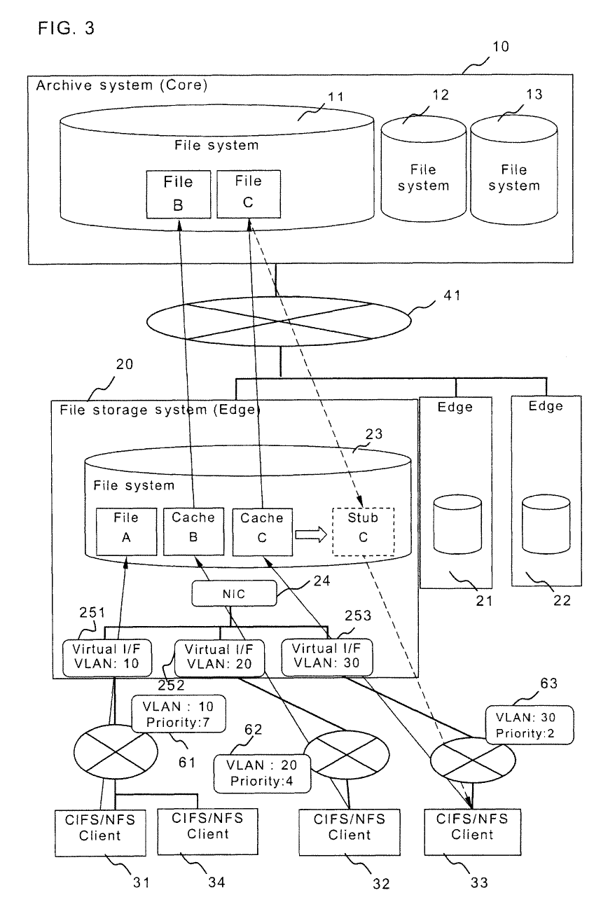

Next, the outline of the operation of a stubbing control will be described with reference to FIG. 3.

(P1) File_C is written from the client 30 to the file system 23 of the edge 20 (file storage system), and thereafter, File_B is written.

(P2) File_A is written from the client 30 to the file system 23 of the edge 20.

(P3) The files in edge 20 are replicated to the core 10 (archive system) (copies of files in edge 20 are created in the core 10) periodically (once a day). The files to be replicated are File_B and File_C. It is also possible to perform migration (according to which the files in the edge 20 are transferred to the core 10 and the files in the edge 20 are deleted) to realize stubbing.

(P4) The replicated files are not deleted but retained in the file system 23 of the edge 20. This status is called cache, enabling to provide an equivalent access performance as normal files (Cache_B, Cache_C).

(P5) When the used capacity of the file system 23 in the edge 20 exceeds a certain threshold (such as 90% of the total capacity of the file system), the files having old access dates are turned into stub files. In that case, the file to be stubbed is the Cache_C written first. The stub file retains only reference data to the file in the core, and does not retain any actual data (Stub_C).

(P6) When clients 31 through 34 access File_A and Cache_B in the edge 20, the data can be accessed at high speed since actual data exists in the edge 20. On the other hand, when the client 33 accesses Stub_C, since there is no actual data in the edge, the actual data must be downloaded from the core 10 to the edge 20 (recall process). In that case, the response time is extended by the recording process in the edge 20 and the accessing of the core 10.

Therefore, the system according to the present invention has the following characteristics.

(N1) The file storage system 20 of the edge 2 (including file systems 11, 12 and 13) provides a file sharing service using a VLAN (Virtual Local Area Network) function standardized by IEEE 802.1q. The file storage system 21 and 22 provides a similar function.

(N2) Priorities according to IEEE 802.1p are set to respective VLAN networks (according to which networks having larger numbers have higher priorities).

(N3) File_A is frequently accessed from VLAN: 10 (network 61) via virtual I/F 251 and NIC 24, Cache_B is frequently accessed from VLAN: 20 (network 62) via virtual I/F 252 and NIC 24, and Cache_C is frequently accessed from VLAN: 30 (network 63) via virtual I/F 253 and NIC 24.

(N4) The file storage system 20 identifies the priority included in the VLAN tag for each access, and determines the priority of the file being cached. According to FIG. 3, regarding the order of priority of the files (files to be left as cache), File_A has the highest priority of “7”, Cache_B has the next priority of “4” and Cache_C has the lowest priority of “2”.

(N5) When the capacity of the file system has exceeded a certain threshold (90% of the total capacity), Cache_C having the lowest priority is stubbed first.

According to such configuration and operation of the whole system, the cache hit rate of client access is improved, and the provided service will have improved quality.

The actual operation will be described with reference to the drawings. First, the functional configuration of the whole system according to one preferred embodiment of the present invention will be described with reference to FIG. 4. The file storage system 20 is composed of an archive function 221, a file system function 222, a file sharing function 223, and a VLAN function 224. The archive function 221, the file system function 222, the file sharing function 223 and the VLAN function 224 constituting the file storage system 20 corresponds to the archive function program 211, the file system function program 212, the file sharing function program 213 and the VLAN function program 214 in FIG. 3.

The archive function 221 is composed of a replication process 2211, a stubbing process 2212, a list creation process 2213, and a recall process 2214, and in the list creation process 2213, a replication list 22131 and a stubbing list 22132 are created and updated.

The file system function 222 is composed of a priority determination process 2221, a file access notification process 2222, and a recall request process 2223. The file access notification process 2222 executes notification of an event when an access request or the like occurs. Upon receiving a recall request 226 generated via the recall request process 2223, data is rewritten from the archive system 10 to the file storage system 20 by the recall process 2214.

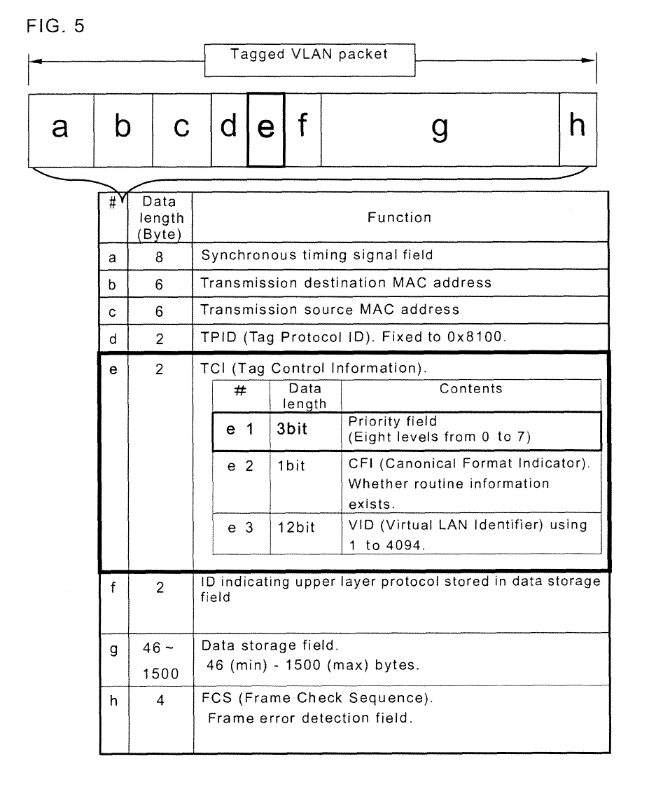

The file sharing function 223 includes an access request reception process 2231. The VLAN function 224 comprises a priority identification process 2241 and a VLAN packet transmission and reception process 2242 for transmitting and receiving tagged VLAN packets as shown in FIG. 5.

Next, the actual operation will be described. First, the transmission and reception of packets will be described with reference to FIGS. 5 through 10. The client 30 executes a data write request with respect to the file storage system 20. At this time, a tagged VLAN packet defined in FIG. 5 is transmitted from the client 30. The structure of the tagged VLAN packet (Ethernet (Registered Trademark) frame format) is as follows.

Section a: A timing signal field for realizing synchronization (data length: 8 bytes)

Section b: MAC address of transmission destination (data length: 6 bytes)

Section c: MAC address of transmission source (data length: 6 bytes)

Section d: TPID (Tag Protocol ID) fixed to 0x8100 (2 bytes)

Section e: TCI (Tag Control Information) composed of the following tag control information (2 bytes).

e1) First 3 bits: Priority field. Priority value to be used by WEE 802.1p (CoS).

e2) Next 1 bit: CFI (Canonical Format Indicator) which indicates whether there is a routine information field or not.

e3) Last 12 bits: VID (Virtual LAN Identifier) which is a VLAN identifier from 1 to 4094.

Section f: Setting up the type (ID indicating the upper layer protocol to be stored in the data storage field (section g)).

Section g: Data storage field storing arbitrary data from 46 to 1500 bytes.

Section h: FCS (Frame Check Sequence). Frame error detection field (4 bytes).

The present invention uses the priority value stored in the priority field of section e1 (3 bits) to determine the order of stubbing.

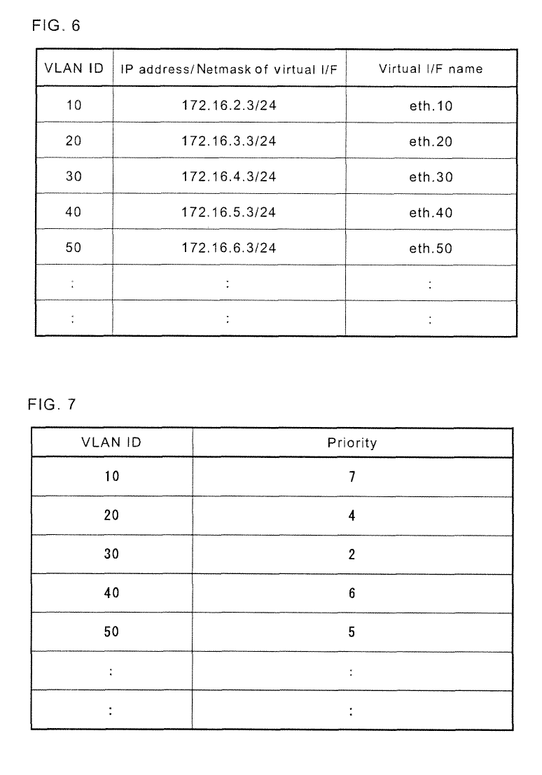

At first, based on the settings information of the virtual I/F of the file storage system 20, a correspondence table of the IP address and VLAN_ID set for the virtual I/F is created (FIG. 6). That is, when a tagged packet in compliance with the standard of IEEE 802.1q is received, the correspondence table of FIG. 6 is used to acquire the virtual I/F from the network address (IP address) of the transmission source, and then the VLAN_ID is specified.

Further, upon responding (transmitting) to the client, the virtual I/F as the transmission source is acquired using FIG. 6 based on the network address (IP address) of the transmission destination, and the corresponding VLAN_ID is assigned. At this time, as shown in FIG. 7, the priority corresponding to the VLAN_ID is acquired, and a priority is assigned to the transmission packet at the time of transmission.

Actually, if the IP address of the client of the transmission destination is 172.16.5.100/24, the virtual I/F belonging to the same network is eth. 40 from FIG. 6, and the VLAN_ID thereof is 40. Further, from the relationship between the VLAN_ID and priority of FIG. 7, the priority of the VLAN_ID: 40 can be recognized as “6”.

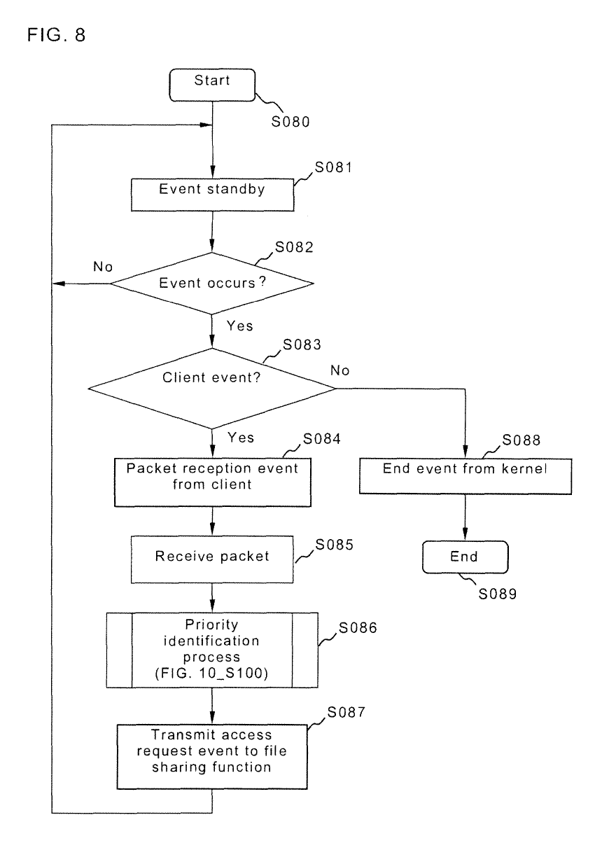

The process performed at the time of reception of the tagged VLAN packet (2242 of FIG. 4) will be described with reference to FIG. 8. Steps S081 and S082 are looped until a request packet 321 from the client 30 is received via the VLAN packet transmitting and receiving function 2242 (event occurs). When a packet is received, it is recognized that an event has occurred, so the procedure exits the loop and advances to step S083 and subsequent steps.

It is determined in step S083 whether the received packet is sent from a client or not, that is, whether the event is a client event or not. When the event is not a client event (No), it is determined that the event is an end event from a kernel/driver (S088), and the process is ended (S089).

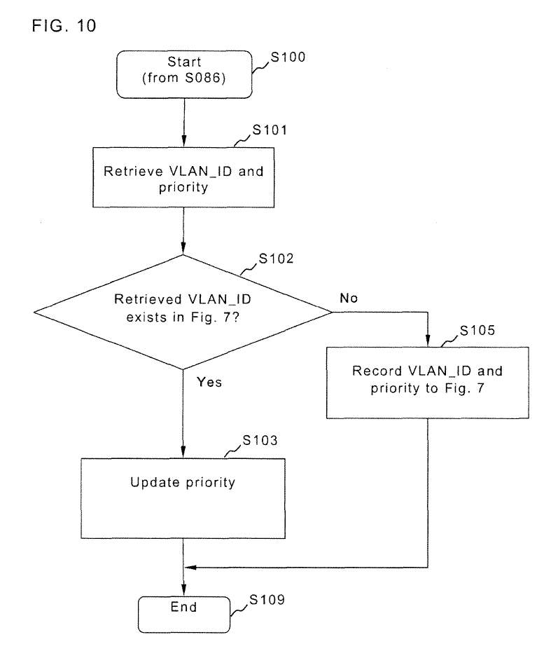

If the event is a client event (Yes), the event is determined to be a packet reception event from the client, and packet reception (S085) is performed. Thereafter, a priority identification process as a subroutine (S086) for analyzing the received packet (corresponding to 2241 of FIG. 4, the process being started from S100 of FIG. 10) is performed.

According to the priority identification process starting from S100 of FIG. 10, the VLAN_ID (VID of section e3 of FIG. 5 (12 bits)) and the priority (priority of section e1 of FIG. 5 (3 bits)) are retrieved from the received packet (S101).

Next, whether or not the retrieved VLAN_ID exists in the VLAN_ID and priority correspondence table of FIG. 7 is determined (S102). When it does not exist (No) (creation of a new file), the VLAN_ID and the priority are recorded in the correspondence table of FIG. 7 (S105). When it exists (Yes), the priority of the VLAN_ID is computed via the following Math. 1, and based on the result, the priority of the correspondence table of FIG. 7 is updated (S103).

The priority Y computed from priority P1 stored in the packet when reference (reading)/writing is performed and priority P2 already stored in the file is stored in the metadata.

Y=Roundup ((P1+P2)/2) (Math. 1)

Y: Priority stored in the file

P1: Priority of the packet for reference/writing

P2: Priority stored in the file at the time of reference/writing

Roundup: Roundup function to an integer

Based on the above calculation, the files being accessed frequently from the network with high priority will have their priorities stored in the metadata gradually increased. Finally, the priority identification process is ended in step S109 and the procedure is returned to step S086. After returning, an access request event (S087) is transmitted (228 of FIG. 4) to the file sharing function (223 of FIG. 4).

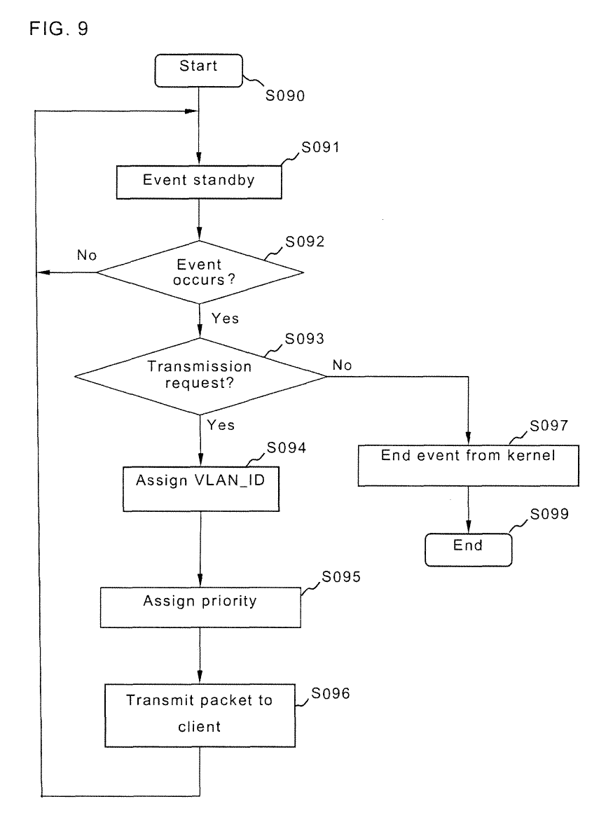

Next, the process during transmission of the tagged VLAN packet (2242 of FIG. 4) will be described with reference to FIG. 9. Steps S091 and S092 are looped until the occurrence of an event. For example, when a reference request (read request) 321 of a file is transmitted from the client 30 in this state, it means that an event has occurred, so the procedure exits the loop and advances to step S093 and subsequent steps.

In step S093, it is determined whether the received packet is sent from a client or not, that is, whether the event is a client event or not. If the event is not a client event (No), the procedure determines that the event is an end event from a kernel/driver (S097), and the process is ended (S099).

When the request is a transmission request (Yes), the VLAN_ID is set (S094) based on the IP address of the transmission destination using the correspondence table of FIG. 6, and the priority P1 is retrieved from the VLAN_ID set in FIG. 7. An update priority Y is calculated using Math. 1 based on the retrieved priority P1 and the priority P2 retained in the reference file. The computed priority Y is assigned to the transmission packet (S095). The packet is transmitted to the client 30 (S096).

As described, the priority of the file can be updated dynamically every time a packet is received from a client 30 (such as writing of a file) and a packet is transmitted to the client 30 (such as the reference (reading) of a file).

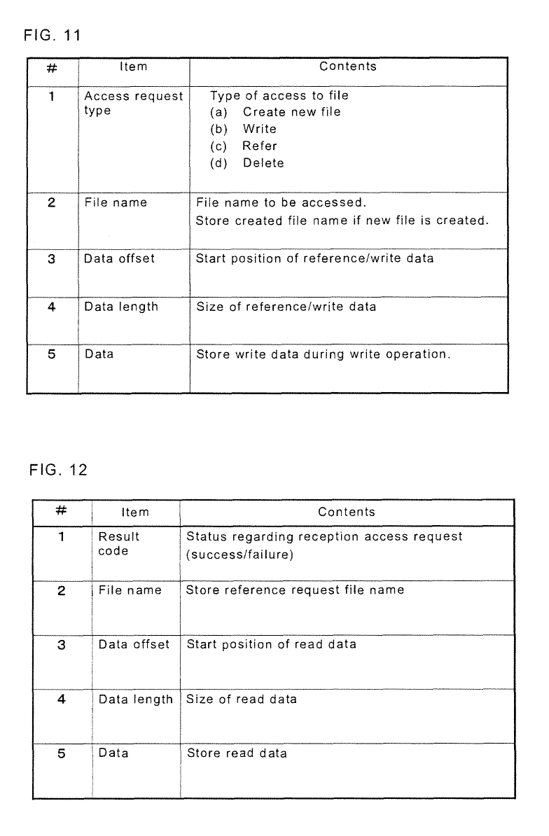

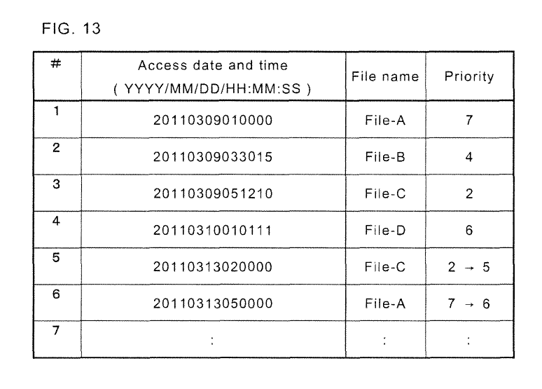

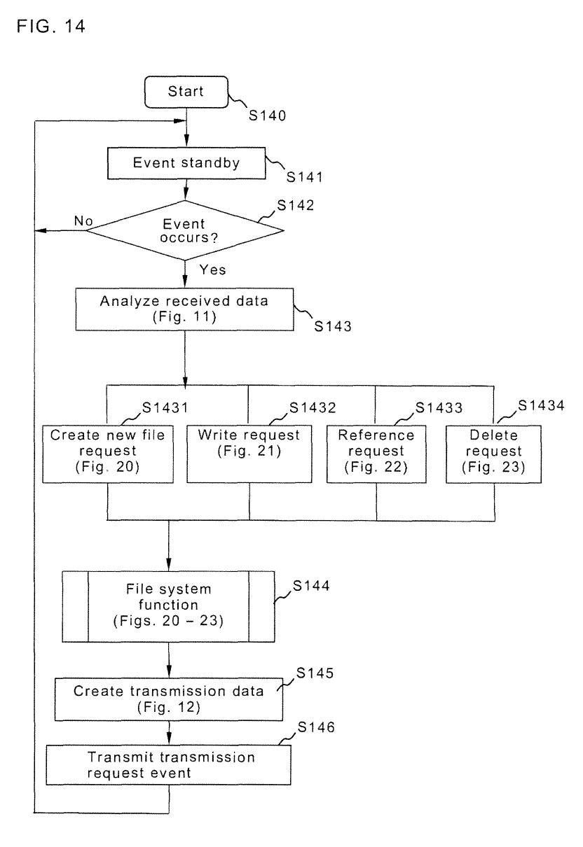

Next, the file sharing function (223 of FIG. 4) will be described with reference to FIGS. 11 through 14. Data transmitted and received by the application of the client 30 and the file sharing function 223 of the file storage system 20 is stored in a data storage field (section g of FIG. 5) of the packet notified by the priority identification process (FIG. 10). The contents thereof are shown in FIGS. 11 and 12.

FIG. 11 shows the contents of data at the time of reception of a packet (data transmitted from the client 30), which includes at least the following:

(11-1): Type of access to file (create new file, write, refer, delete)

(11-2): File name

(11-3): Data offset (start position of reference or writing)

(11-4): Data length (size of writing or reference data)

(11-5): Actual data (write data to be written)

FIG. 12 shows the contents of data at the time of transmission of a packet (data transmitted to the client 30), which includes at least the following:

(12-1): Result of received access request (success or failure)

(12-2): File name (storing reference file name)

(12-3): Data offset (storing start position of read data)

(12-4): Data length (storing read data size)

(12-5): Actual data (storing read data)

The priority of the file subjected to the access request is identified based on the transmission data (information of FIG. 11) form the VLAN function 224 and the priority, and upon requesting access to the file system function 222, the file name, the priority and the access date are also notified (227 of FIG. 4). The correspondence relationship thereof is shown in FIG. 13.

The actual process flow of the access request reception process 2231 of the file sharing function 223 is illustrated in FIG. 14. Steps S141 and S142 are looped until an event occurs. When a request from a client 30 occurs in this state, it is recognized that an event has occurred (proceed to Yes in S142).

At first, the contents of the received data (FIG. 11) are analyzed (S143). The result is classified into a create request of new file (S1431), a write request (S1432), a reference request (S1433), or a delete request (S1434). The classified result is notified to the file system function 222, and a predetermined process (subroutine S144) is executed.

Based on the executed result, the transmission data to the client is created based on FIG. 12 described earlier (S145). After creating the data, a transmission request event 227 is transmitted to the file sharing function 223, and an event standby routine is executed again to wait for the occurrence of an event.

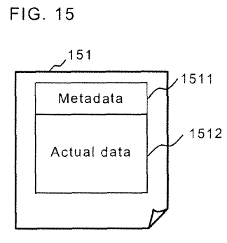

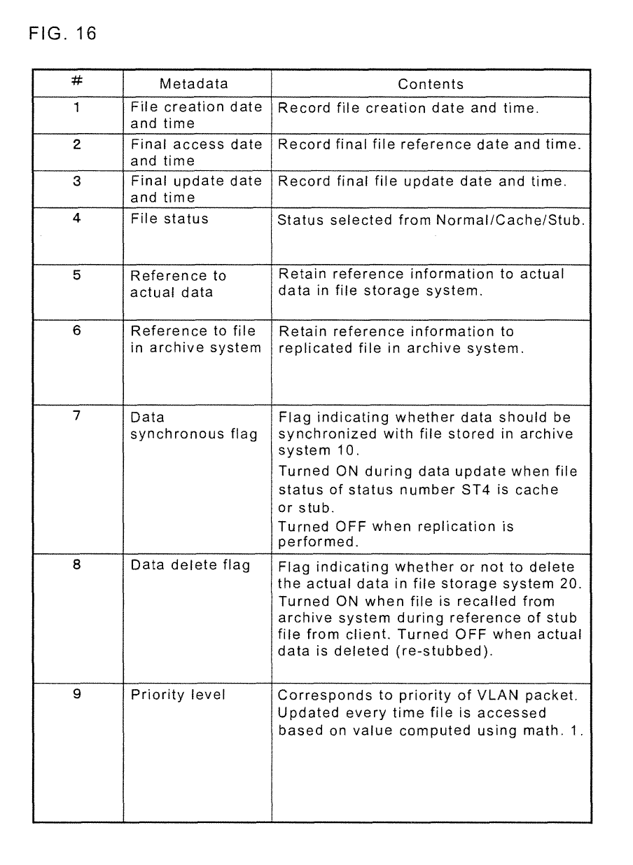

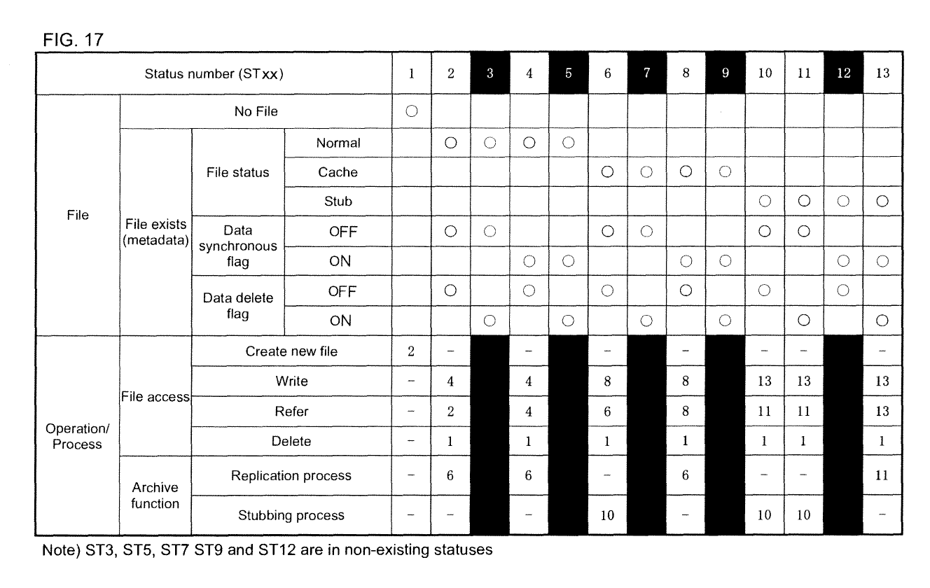

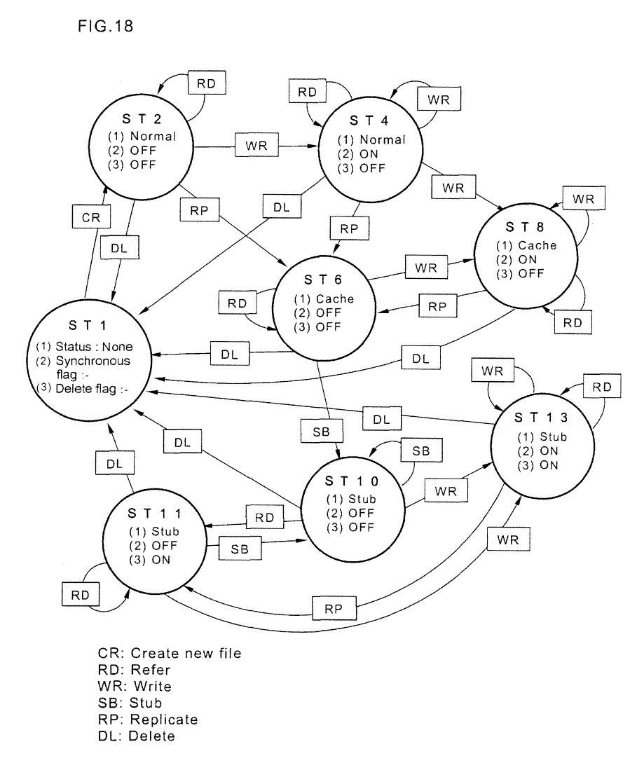

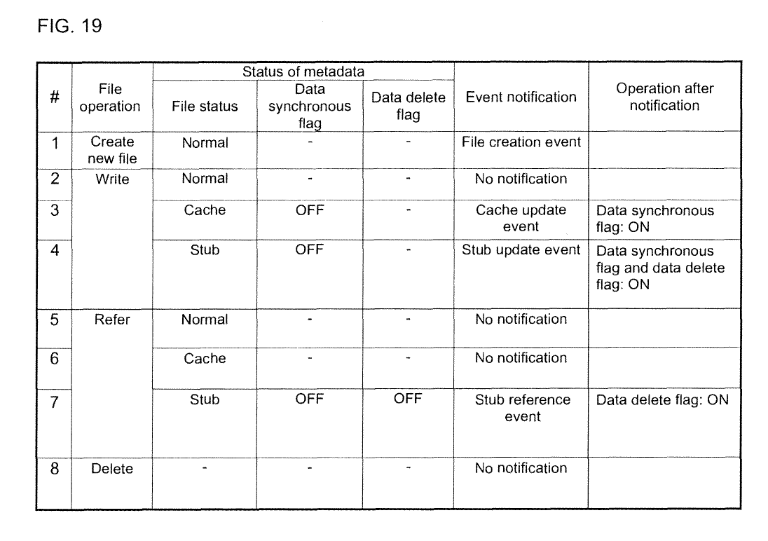

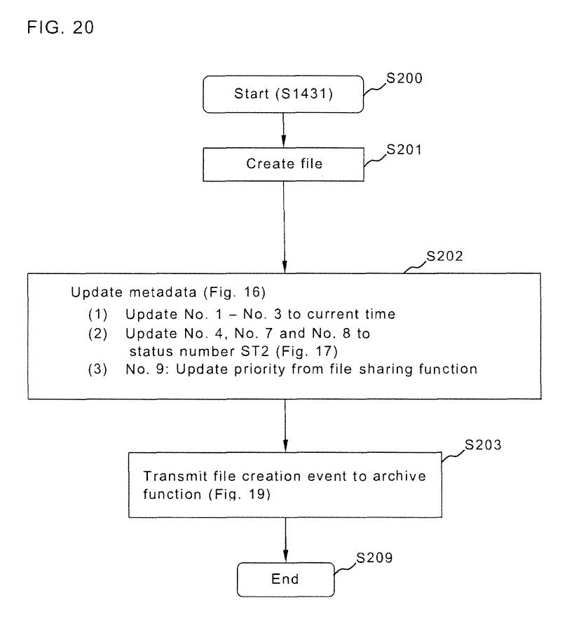

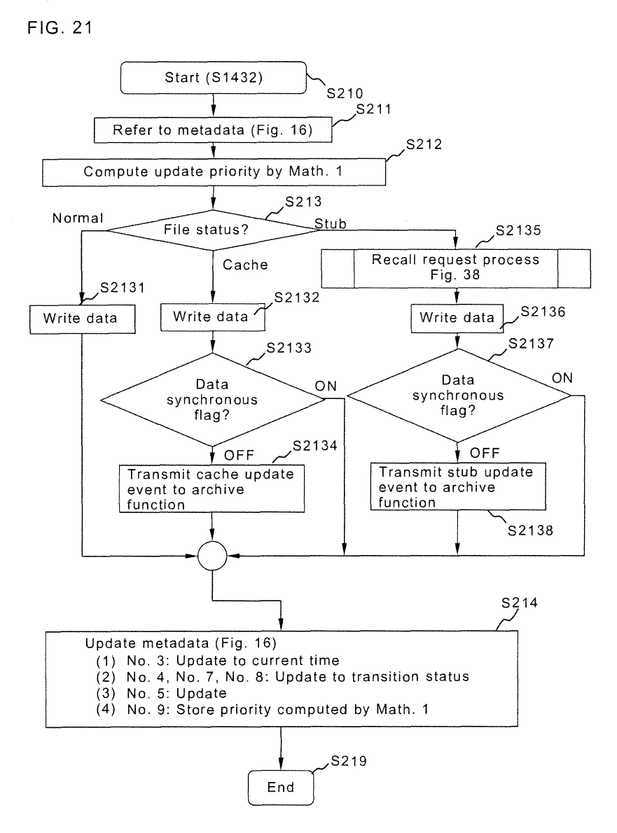

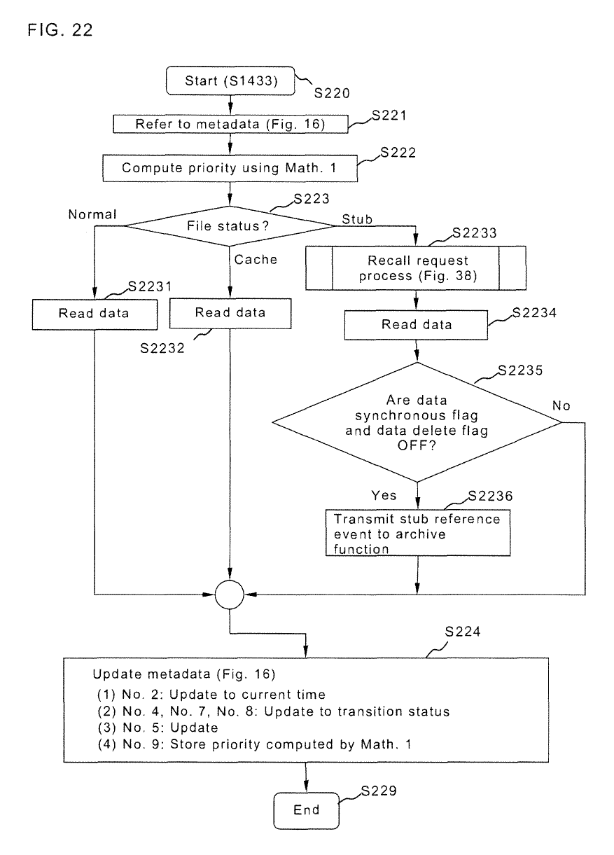

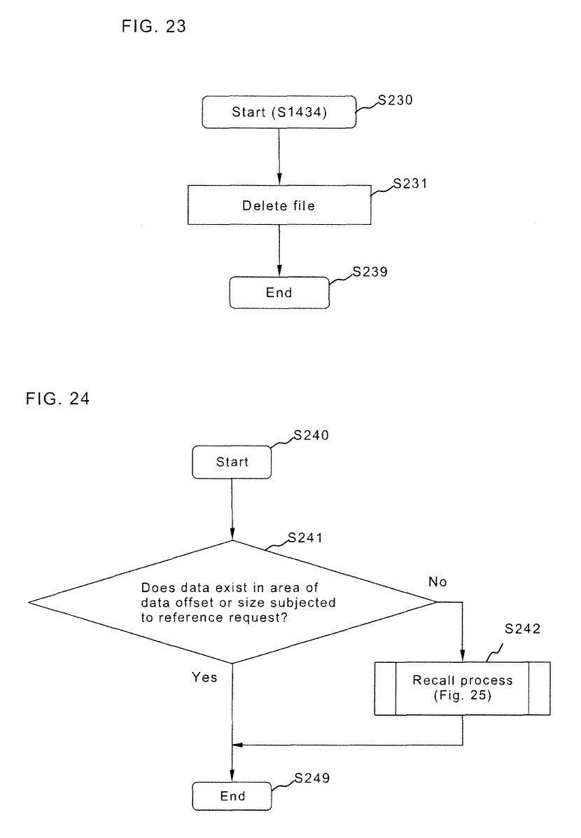

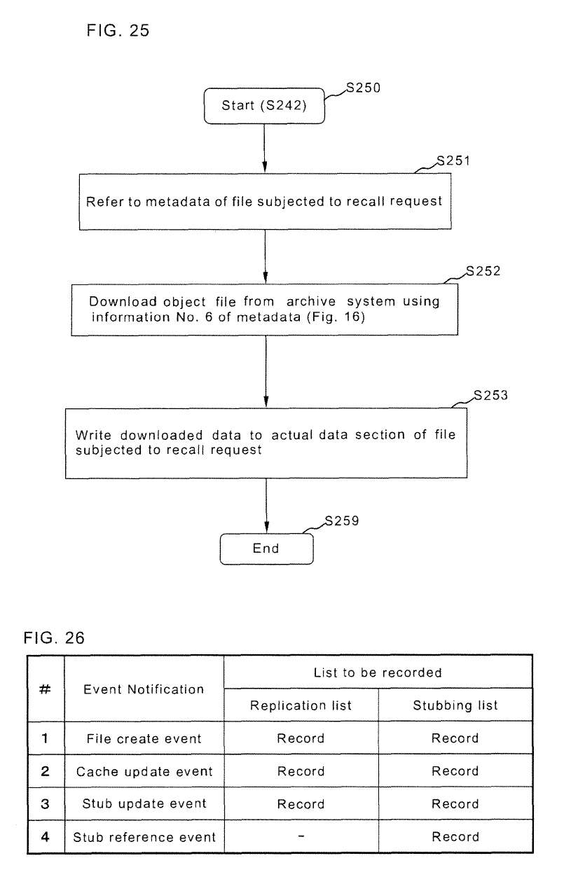

The file 151 stored in the file system has a structure illustrated in FIG. 15, and the metadata 1511 stores management information of the actual data 1512. The contents of the metadata are shown in FIG. 16. The various states and flags included in the metadata are transited (states are changed) as shown in FIGS. 17 and 18 in response to the operations (reference/update) performed to the files or by the processes performed by the archive function.

The contents of the metadata are as follows.

(16-1): File creation date (recording the date when the file was created)

(16-2): Final access date (recording the final reference date of the file)

(16-3): Final update date (recording the final update date of the file)

(16-4): File status (recording the status of the file selected from normal/cache/stub)

(16-5): Reference to actual data (recording the reference to the actual data in the file storage system 20)

(16-6): Reference to file in the archive system 10 (recording the reference to the replicated file)

(16-7): Data synchronous flag

(16-8): Data delete flag

(16-9): Priority

The data synchronous flag discriminates whether the file stored in the archive storage system 10 must be synchronized with the file in the file storage system 20.

The data synchronous flag is turned ON when update (writing) of data occurs. In other words, when writing occurs in any of the states of status numbers ST2, ST6, ST10 or ST11, the data synchronous flag is turned ON. At this time, the status is transited from ST2 to ST4, from ST6 to ST8, or from ST10 and ST11 to ST13. The synchronous flag is turned OFF when replication is performed.

The data delete flag indicates whether or not to delete the actual data in the file storage system 20. The data delete flag is turned ON when a stubbed file is referred to from the client and a file is recalled from the archive system 10. At this time, when the actual data is deleted (re-stubbed), the data delete flag is turned OFF.

The priority corresponds to the value of the priority included in the tagged VLAN packet, and has a value from 0 to 7. Further, the value is updated to a value computed by Math. 1 every time the file is accessed, as mentioned earlier. In other words, the file being accessed frequently from networks having high priority will have their priorities stored in the metadata increased.

In FIG. 17, ST3, ST5, ST7, ST9 and ST12 are in non-existing statuses, which is also clear from the fact that there are no records on file access or transition of statuses by the execution of the archive function.

Next, the file access notification process 2222 will be described. When a file in the file system 23 is accessed, a notification of an event 225 as shown in FIG. 19 is performed to the archive function 221 in accordance with the type of access and the metadata.

A “file creation event” is notified when the file operation 227 is “create new file” (No. 1 of FIG. 19), a cache update event (No. 3) or a stub update event (No. 4) is notified when the operation is “write”, and a stub reference event (No. 7) is notified when the operation is “reference (read)”. After the notification, the data synchronous flag and the data delete flag are changed to predetermined statuses.

Further, the priority of a file is notified together with the event notification. File function processes for respective file accesses are described with reference to FIGS. 20 through 23. Further, the subroutine call of the file sharing function 223 (S144 of FIG. 14) corresponds to FIGS. 20 through 23.

FIG. 20 shows the flow of the priority determination process and the file access notification process by the file system function when a create request of a new file is output (transition from status number ST1 to ST2. First, a file 151 of FIG. 15 (composed of metadata 1511 and actual data 1512) is created (S201). Next, the contents of metadata illustrated in FIG. 16 are updated (S202).

Actually, the following steps are performed.

(20-1): Update the date information of No. 1 through No. 3 to current time.

(20-2): Set the file status of No. 4 to “Normal”, and the data synchronous flag of No. 7 and the data delete flag of No. 8 to “OFF”.

(20-3): The priority of No. 9 is updated to the priority notified by the file sharing function 223.

After step S202 is completed, a “file creation event” is notified to the archive function 221 (S203) as shown in No. 1 of FIG. 19. After the notification, the process is completed (S209) and the procedure is returned to S144.

FIG. 21 illustrates the flow of the priority determination process and the file access notification process upon receiving a write request of a file. At first, the metadata of a file in the file system 23 and the metadata of the write file data are referred to (S211). The priority data of the metadata and Math. 1 are used to compute the update priority (S212).

Next, the status of the file is determined (S213). If the file is in normal status, the writing is executed without any change (S2131). If the file is in cache status, writing of data (S2132) is performed, and the status of the data synchronous flag is confirmed (S2133). If the data synchronous flag is ON, step S214 is executed, and if the flag is OFF, a cache update event is notified to the archive function 221 (S2134), and thereafter, step S214 is executed.

If it is determined in S213 that the file is in stubbed status, the process executes in step S2135 the recall request process (FIG. 38), and then writing of data is performed (S2136). Next, the status of the data synchronous flag is confirmed (S2137). If the data synchronous flag is ON, step S214 is executed, and if the flag is OFF, a stubbing update event is transmitted to the archive function 221 (S2138), and thereafter, step S214 is executed.

In step S214, the following steps are performed for the metadata of FIG. 16.

(21-1): Update the final update date of No. 3 to the current time.

(21-2): Update the file status of No. 4, the data synchronous flag of No. 7 and the data delete flag of No. 8 according to the transition table of FIG. 17.

(21-3): Update the actual data reference information of No. 5.

(21-4): Update the priority of No. 9 based on the result computed by Math. 1

Thereafter, the write request process is ended (S219). After ending the process, the procedure is returned to S144.

FIG. 22 shows the flow of the priority determination process and the file access nodfication process when a reference request of a file is received.

At first, the metadata of a file in the file system 23 and the metadata of the write file data are referred to (S221). The priority in the metadata and Math. 1 are used to compute the update priority (S222).

Next, the status of the file is determined (S223). If the file is in normal status, the writing (reference) of data is executed without any change (S2231). If the file is in cache status, writing (reference) of data (S2232) is performed as it is. If it is determined in S223 that the file is in stubbed status, the recall request process (FIG. 38) mentioned earlier is executed in step S2233, and then the reading of data is performed (S2234).

Next, the statuses of the data synchronous flag and the data delete flag are confirmed (S2235). If both flags are OFF (Yes), a stub reference event is transmitted (S2236) to the archive function 221, and thereafter, step S224 is executed. If the data synchronous flag or the data delete flag is ON, step S224 is executed without any change.

In step S224, the following steps are performed for the metadata of FIG. 16.

(22-1): Update the final access date of No. 2 to the current time.

(22-2): Update the file status of No. 4, the data synchronous flag of No. 7 and the data delete flag of No. 8 according to the transition table of FIG. 17.

(22-3): Update the actual data reference information of No. 5.

(22-4): Update the priority of No. 9 to the result computed by Math. 1

Thereafter, the reference request process is ended (S229). After ending the process, the procedure is returned to S144.

FIG. 23 shows the flow of the priority determination process and the file access notification process when a delete request of a file is received. The present process simply deletes the relevant file (S231) and ends the delete process (S239). After the process is ended, the procedure returns to S144.

Next, the recall request process 2214 will be described. When a reference or read access occurs to a file in stubbed status, the data must be downloaded (rewritten) from the archive system. In this case, recalling (rewriting) of data is requested independently from event notification to the archive function 221.

FIG. 24 shows the process flow of the recall request 2223 according to the file system function 222, and FIG. 25 shows the process flow of the recall process 2214. According to the recall request process, it is determined whether data exists or not in the area of the data offset or size of the file subjected to the read request (reference request) (whether the file exists in the file system 23) (S241).

If data exists (Yes), the recall request process is ended (S249). If data does not exist (No), the recall process S242 shown in FIG. 25 (the recall process function 2214 of the archive function 221, the recall request 121 to the archive system 10) is executed, and after completing execution, the recall request process is ended (S249). After the process is ended, the process is returned to either S2135 of FIG. 21 or S2233 of FIG. 22.

In the process of the recall process function 2214 of the archive function 221, at first, the metadata of the file subjected to the recall request is referred to (S251). Next, based on the reference information of the file in the archive system 10 in No. 6 of the metadata (FIG. 16), the object file is downloaded from the archive system 10 (S252). Thereafter, the downloaded data is written in the actual data section of the file subjected to the recall request (S253), and the recall process is ended (S259). After ending the recall process, the procedure is returned to S242 of FIG. 24.

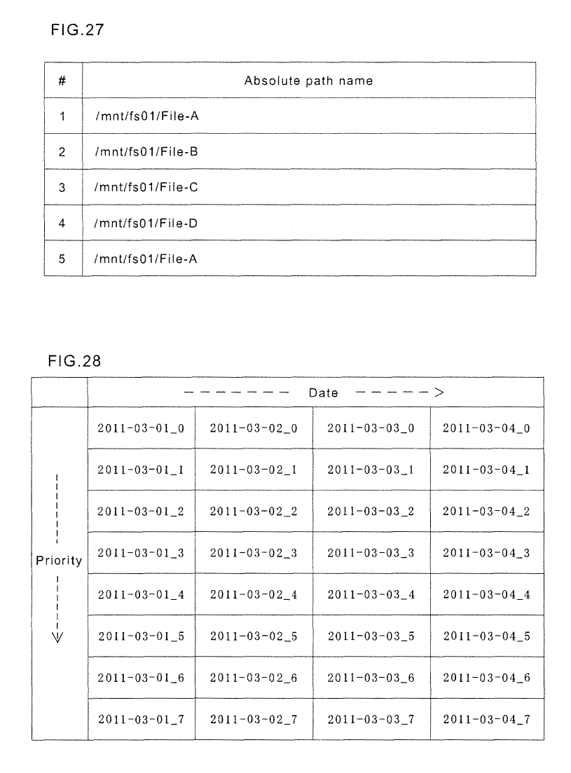

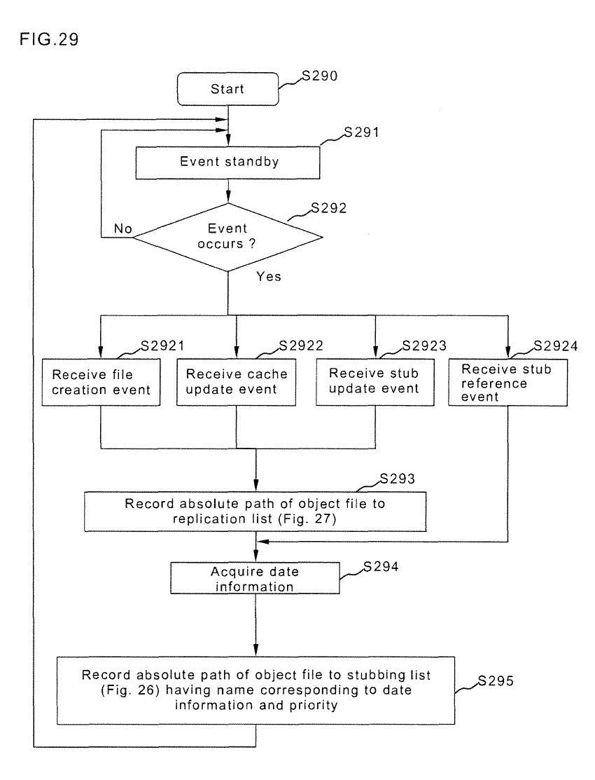

Next, we will describe the archive function 221. First, the list creation process 2213 monitors the event 225 notified from the file system function 222, and creates two kinds of lists, a replication list 22131 and a stubbing list 22132, in response to the notified event. The correspondence thereof is shown in FIG. 26. The replication list 22131 records the object files by their absolute paths, as shown in FIG. 27.

On the other hand, the stubbing list 22131 is created by assigning the date of occurrence of the event and the priority as the name of the list, as shown in FIG. 28. For example, 2011-03-01-0 indicates that the file was stubbed on Mar. 1, 2011, and the priority thereof is “0”. As for the contents of the respective stubbing lists, the object files are recorded by their absolute paths, similar to the replication list of FIG. 27.

The flow of the list creation process is shown in FIG. 29. The process monitors the occurrence of an event notification 225 notified from the file system function 222 (the loop of S291 and S292). When an event occurs (Yes), the process analyzes the content of the notified event.

If the result of analysis is the reception of a file creation event (S2921), the reception of a cache update event (S2922) or the reception of a stub update event (S2923), the absolute path of the object file is recorded in the replication list of FIG. 27 (S293). Thereafter, the current date is acquired (S294). The absolute path of the object file is recorded in the stubbing list having a name corresponding to the acquired date and the priority (S295).

If the result of analysis is the reception of a stub reference event (S2924), the current date is acquired (S294). The absolute path of the object file is recorded in the stubbing list having a name corresponding to the acquired date and the priority (S295). As described, the sequence of the list creation process is ended, and the process returns to monitoring the occurrence of an event notification 225.

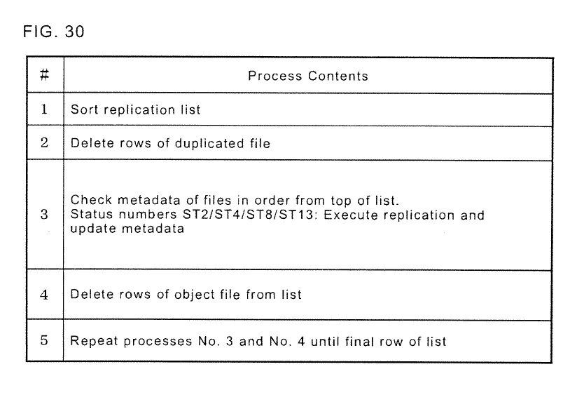

Next, we will describe the process for replication (in which a copy of a file in the file system 23 of the file storage system 20 on the edge side is created in the archive system 10 on the core side). The present process is invoked periodically (once a day, for example) from the scheduling function of the kernel/driver 215, and the process shown in FIG. 30 is executed.

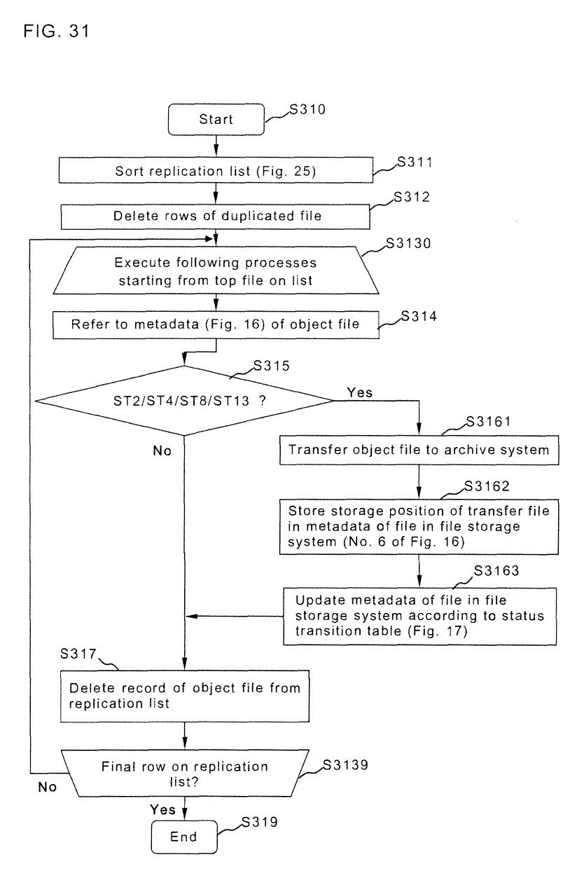

(30-1): The replication list is sorted (S311 of FIG. 31).

(30-2): Duplicated rows are deleted except for one row (S312).

(30-3): The metadata of the files are referred to in order from the top of the sorted list (S314) to determine whether the status number of FIG. 17 is ST2, ST4, ST8 or ST13 (S315). If the status number is any of the aforementioned status numbers (Yes), the object file is transferred to the archive system 10 (S3161). Then, the file storage position information is stored in No. 6 (reference to file in archive system 10) of the metadata (FIG. 16) (S3162). Thereafter, the metadata of the file in the file storage system 10 is updated by the status information after the transition of status (S3163).

(30-4): The description of the object file is deleted from the replication list (S317).

(30-5): The processes of (30-3) and (30-4) are executed until the final file on the sorted replication list (S3139).

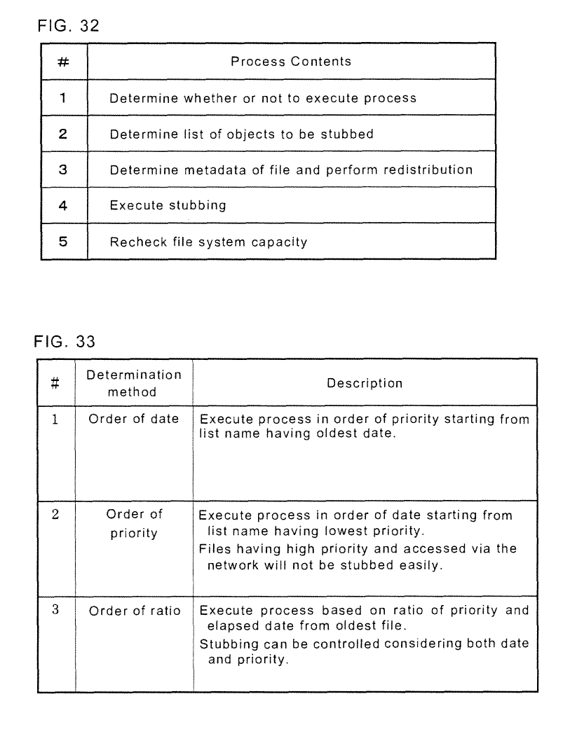

Next, the stubbing process will be described. FIG. 32 shows a table of the contents of the stubbing process. The contents are as follows:

(32-1): Determine whether or not to execute the stubbing process (compare capacity with stubbing execution threshold value)

(32-2): Determine the list of objects to be stubbed (select the determination method of FIG. 33)

(32-3): Determine the metadata of the file and execute redistribution thereof

(32-4): Execute stubbing (delete data section)

(32-5): Reconfirm the capacity of the file system 23 (compare capacity with stubbing restoration (stubbing suspension) threshold)

The present process is invoked periodically (for example, once every 30 minutes) from the scheduling function of the kernel/driver 215. The file storage system 20 checks the used amount of the file system 23, and when the amount exceeds a stubbing execution threshold (90% of the file system capacity), the stubbing operation is executed and continued until the used amount falls to or below a stubbing restoration threshold (80% of the file system capacity). Further, in order to use the file system efficiently and to prevent significant delay of the access processes, the stubbing execution threshold should be in the range of approximately 85% to 95% of the overall capacity, and the stubbing restoration threshold should be in the range of approximately 75% to 85% of the overall capacity.

First, the determination of the list of objects to be stubbed (selection of determination method of FIG. 33) will be described with reference to FIGS. 33 to 37. According to No. 1 “Order of date” of FIG. 33, the process is performed in the order of priority from the list name having the oldest date.

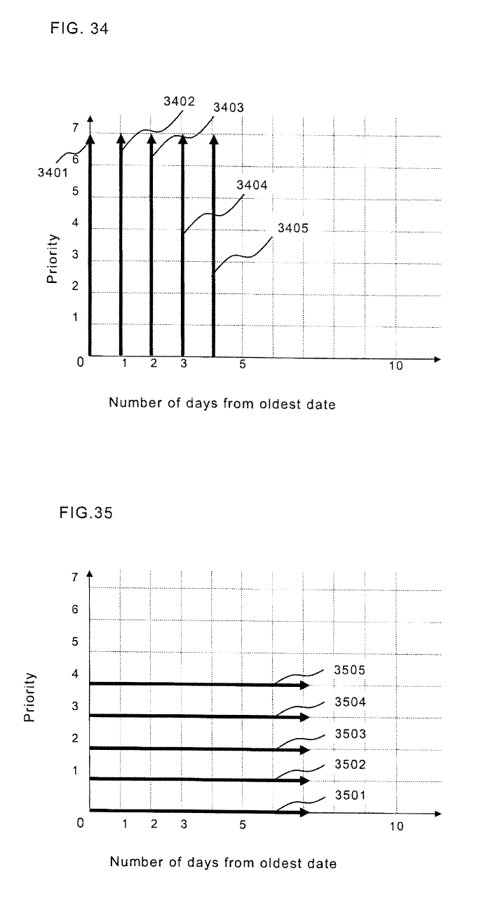

The processing order thereof will be described with reference to FIG. 34. The oldest file (in which the difference between the date information of the oldest file and the date information of the relevant file is small) is on the left side of the drawing, and the files become newer toward the right side (in which the aforementioned difference is great). In other words, 3401 is oldest, and 3405 is newest. Further, the lower ends in the arrows on the drawing have lower priorities, and the priorities are increased as the position moves upward.

According to the present process in the order of date, at first, determination on whether to perform stubbing or not is performed in the oldest file group 3401 starting from those having the lowest priority “0” and working upwards toward priority “7” (so that the process is performed from the lower side of the arrow toward the upper side thereof). When the process of the file group 3401 is completed, then file group 3402 is subjected to determination, and thereafter, file groups 3403, 3404 and 3405 are sequentially subjected to determination on whether to perform stubbing or not. According to this method, the files having older dates are stubbed (deleted).

According to the method performed in the “order or priority” in No. 2 of FIG. 33, processing is performed in order of date (from left to right in the drawing) starting from the list name having the lowest priority (3501 of FIG. 35). In other words, the present determination method gives weight to priority, and the files of networks having high priorities tend to remain (for example, files corresponding to 3505).

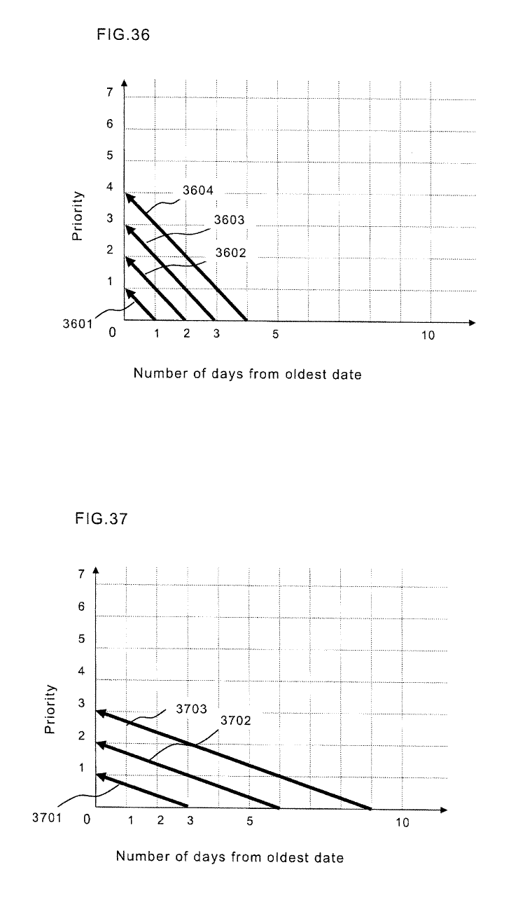

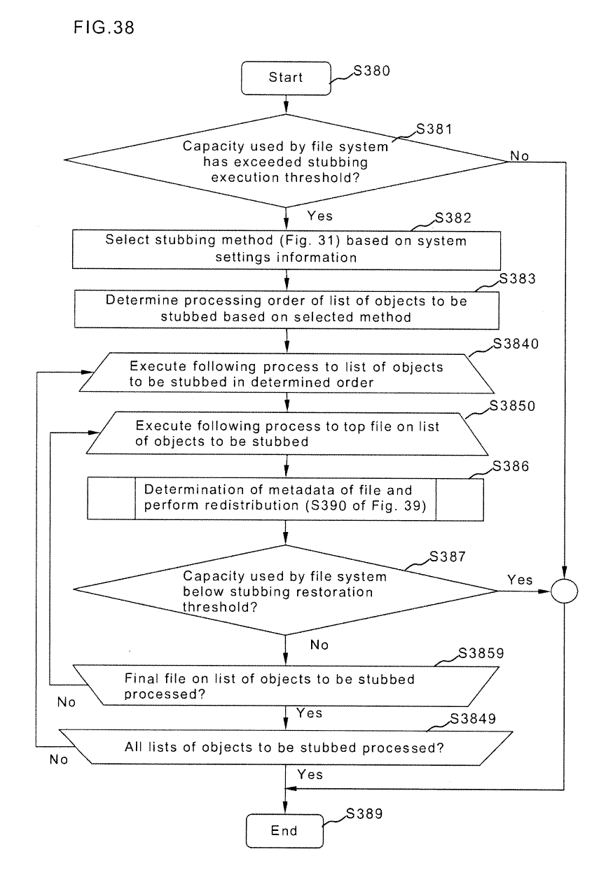

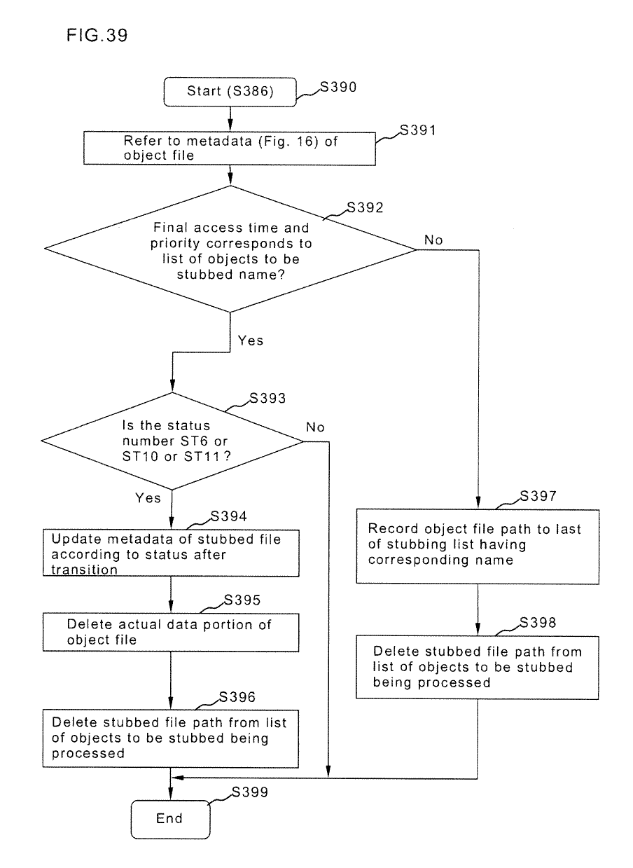

According to the method in the “order of ratio” in No. 3 of FIG. 33, the stubbing process is performed based on the ratio (weighting) of the priority and the date information from the oldest file. The images thereof are shown in FIGS. 36 and 37. FIG. 36 has the ratio of priority and date information set to 1:1, and FIG. 37 has the ratio set to 1:3. According to this method, the stubbing operation can be controlled by considering both date and priority. The ratio is not restricted to that described earlier, and can be flexibly selected based on the used capacity of the file system, the number of stored files or the sizes thereof.

Next, the overall operation of the stubbing process will be described with reference to FIGS. 38 and 39. FIG. 38 illustrates the overall flow of the stubbing process, and FIG. 39 illustrates the flow of metadata determination and redistribution process according to the stubbing process.

In FIG. 38, when a processing request (S380) is received from the scheduling function of the kernel/driver 215, the process of step S381 and subsequent steps is started. First, the used capacity of the file system 23 is checked. If the used capacity is below the stubbing execution threshold (No), the process is ended. If the used capacity is equal to or greater than the threshold (Yes), the process of steps S382 and subsequent steps is continued.

First, the stubbing method of FIG. 31 is selected based on a system settings information determined in advance (S382). Next, the processing order of the list of objects to be stubbed is determined based on the selected determination method (S383). Then, the steps of S3850 to S3859 are performed to the list of objects to be stubbed in the determined order (S3840).

The contents of the process is to perform, to the files in the list of objects to be stubbed starting from the first file on the list, the determination of metadata and the redistribution process of the file (S386) and to determine whether or not the used amount of the file system after performing the process falls below a stubbing restoration threshold (S387). If this process is performed and the used amount of the file system becomes smaller than the stubbing restoration threshold (Yes), then the process is ended.

If the used amount does not become smaller than the stubbing restoration threshold, then the next file is subjected to metadata determination and redistribution process for similar determination. If the used amount does not becomes smaller than the stubbing restoration threshold even when all the files in one list of objects to be stubbed is subjected to metadata determination and redistribution process, then a similar process (S3850 to S3859) is performed to the next list of objects to be stubbed. As described, the lists of objects to be stubbed and the files in the lists are changed sequentially to perform the metadata determination and redistribution process until the used amount becomes smaller than the stubbing restoration threshold.

The detailed operation of the determination of metadata and redistribution process (S386) will be described with reference to FIG. 39. First, the metadata (FIG. 16) of the object file is referred to (S391). Whether or not the newer date of the final access date (No. 2) and the final update date (No. 3) and the priority in that metadata correspond to the date and priority in the name of the list of objects to be stubbed being processed is determined (S392).

If both the date and the priority correspond (Yes), it is determined whether the status of the metadata (No. 4: file status, No. 7: data synchronous flag and No. 8: data delete flag of FIG. 16) corresponds to any of status numbers ST6, ST10 or ST11 in FIG. 7 (S393). If it corresponds (Yes), the metadata of the file being stubbed is updated according to the transition of FIG. 17 (S394). Thereafter, the actual data portion of the object file is deleted (S395), the file pass of the stubbed file is deleted from the list of objects to be stubbed being currently processed (S396), and the process is ended (S399).

If the access time and priority does not correspond to the name in the list in step S392 (No), the object file path is added to the last of the stubbing list to which the date and priority correspond (S397). Then, the object file path is deleted from the list of objects to be stubbed being currently processed (S398). When all the processes are ended (S399), the procedure returns to S386 of FIG. 38.

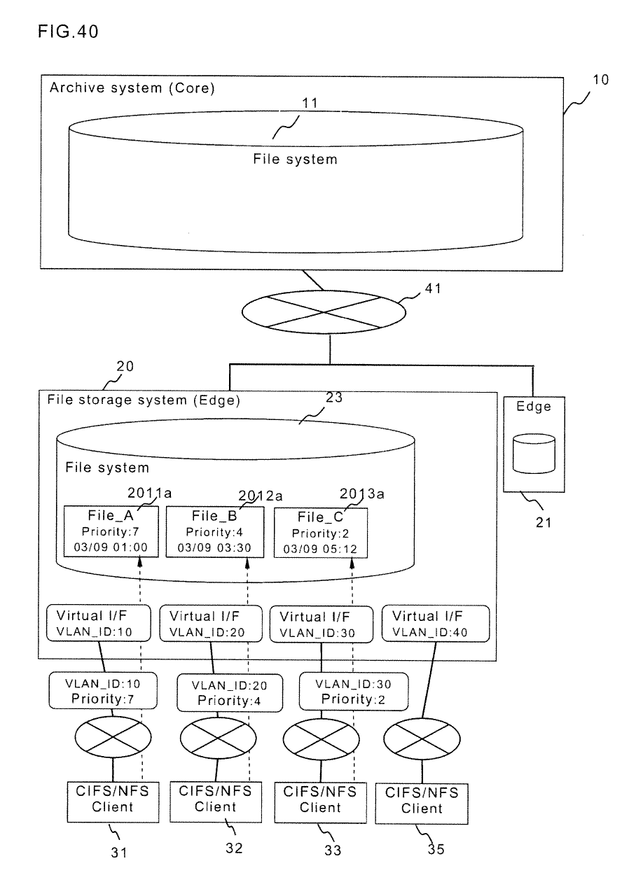

Next, the sequence of operations from creating a new file to stubbing and reference of a file will be described with reference to FIGS. 40 through 45.

In FIG. 40, the clients respectively connected to networks having their VLAN_IDs and priorities set write File_A 2011a, File_B 2012a and File_C 2013a sequentially onto the file system 23 in the file storage system 10 (edge) via virtual I/Fs (the VLAN packet transmission and reception process 2242 (FIG. 8) of FIG. 4, and the priority identification process 224) (FIG. 10) of FIG. 4). At this time, the file creation date and time and the priority (the priority determination process 222) of FIG. 4) are stored in the metadata (FIG. 16) of the respective files (the access request reception process 223) (FIG. 14) of FIG. 4 and create new file (FIG. 20)).

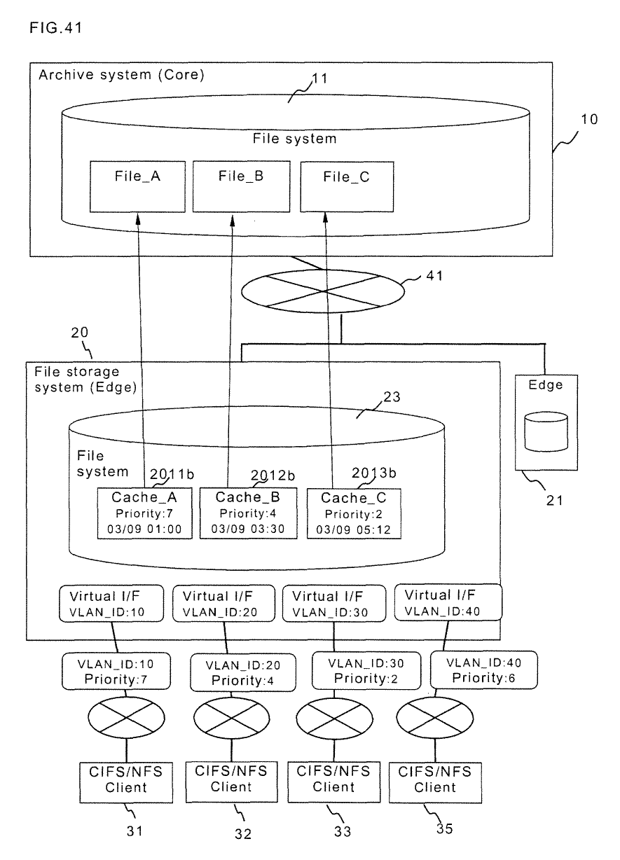

As shown in FIG. 41, if a certain time (such as one day) has elapsed after writing of a file, the replication process (the replication process 2211 and the list creation process 2213 of FIG. 4) is executed, by which copies of respective files are created in the file system 11 of the archive system 10, and the files in the file system 23 are turned into cache statuses (2011b, 2012b, 2013b) (FIG. 3)). At this time, the replication list 2213) (FIG. 27) is created and recorded.

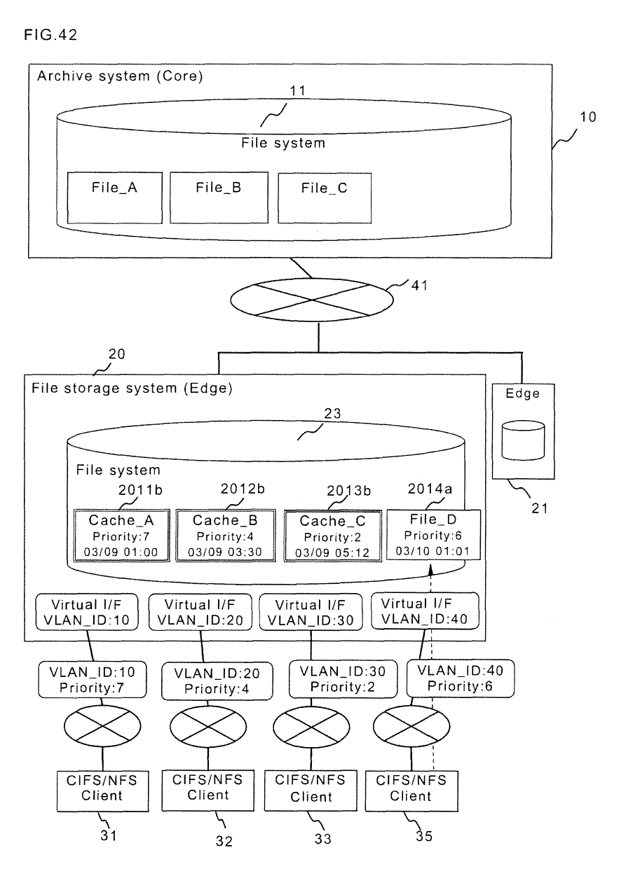

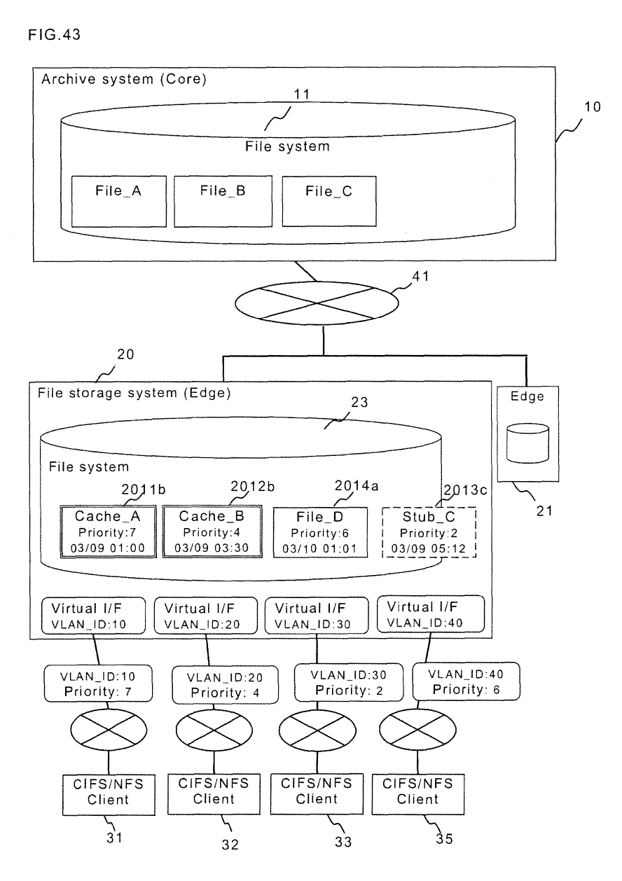

As shown in FIG. 42, if the client 35 attempts to write File_D 2014a, the capacity of the file system will exceed the stubbing execution threshold (90% of the overall capacity). Therefore, as shown in FIG. 43, the stubbing process 2212 (FIG. 38, FIG. 39) is performed based on the priority and the difference of date information from the oldest file. In the present drawing, Cache_C 2013b having the lowest priority and which is oldest is stubbed (deleted), and a stubbing list FIG. 28 is created and recorded. According to this process, the capacity of the file system will fall below the stubbing restoration threshold (80% of the overall capacity), so that the capacity will not exceed the stubbing execution threshold even when File_D 2014a is written (FIG. 21).

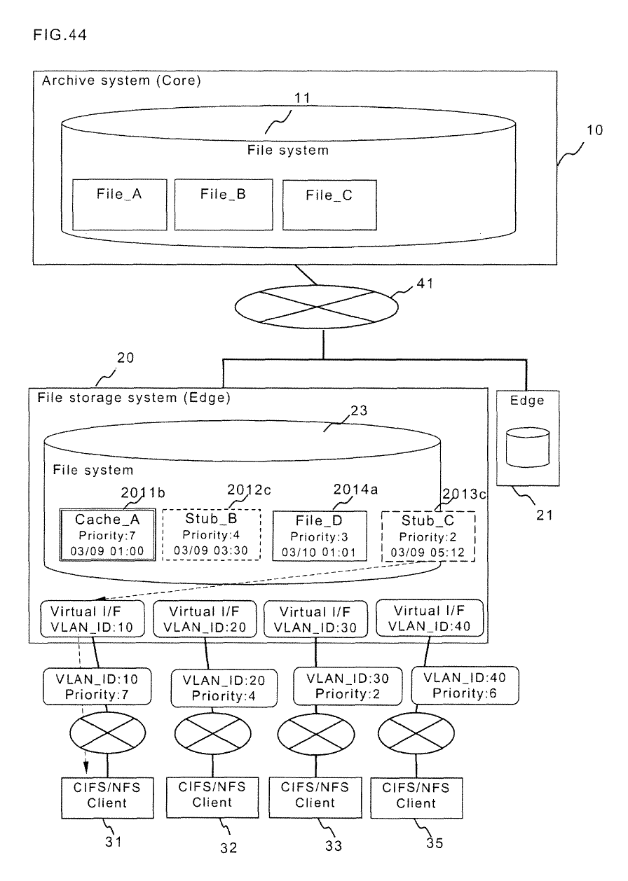

Next, as shown in FIG. 44, the client 31 connected to VLAN_ID: 10 with priority: 7 refers to a stubbed file Stub_C 2013c (FIG. 22). In this case, the actual data does not exist in the file system 23 (FIG. 24), so a recall process (FIG. 25) must be performed. However, if File_C is read out from the archive system 10 and rewritten, the capacity of the file system will against exceed the stubbing execution threshold. Therefore. Cache_B 2012b having a low priority and which is old is stubbed (FIG. 38, FIG. 39), so that the capacity will fall below the stubbing restoration threshold.

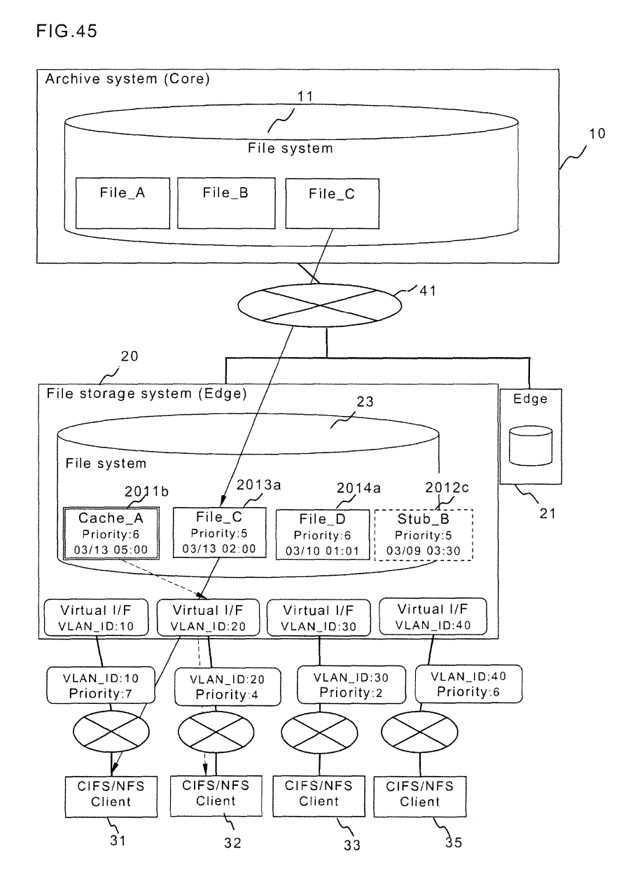

Thereafter, File_C 2013a is written in the file system 23, and at that time, the final access date and priority stored in the metadata are changed. The update of priority is computed via Math. 1 using the priority “2” and the priority “7” of the network to which the client in access is connected. In other words, (2+7)/2=4.5 is rounded up to “5”. This state is shown in FIG. 45. Adversely, when the client 32 with VLAN_ID: 20 (priority “5”) accesses Cache_A 2011b, the priority is lowered to “6” ((7+4)/2=5.5 rounded up to “6”). The final access time as date information of the File_C 2013a is updated from 2011/03/09-05:12:10 (No. 3 of FIG. 13) to 2011/03/13-02:00:00 (No. 5 of FIG. 13), and File_A is similarly updated.

The above description has illustrated a replication process and a stubbing process, but the replication and stubbing operations can be performed simultaneously such as in a migration operation.

As described, the priority information included in the network packet is used for determining the priority of the file to be stubbed. Files being frequently accessed from networks having high priorities are prevented from becoming the object of stubbing (deleted), so that in other words, the files are constantly available in the file storage system and could be accessed at high speed.

Thus, the variety of networks (levels of priority) to which the clients are connected can be selected freely, and a high speed file access service responding to the demands of clients can be provided.

In the above-described embodiments, various information and data are referred to through drawing numbers or names of tables, but they are not restricted to such examples, and can be expressed in different ways. Further, the present system has been described as being composed of three components, which are the core (archive system), the edge (file storage system) and the clients (CIFS/NFS clients), but the system can also be composed of two components, which are an integrated core (archive system) and edge (file storage system) and the clients.

### INDUSTRIAL APPLICABILITY

The present invention is applicable to information processing apparatuses and storage systems in general capable of accessing data via communication networks.

### REFERENCE SIGNS LIST

1 Core (collective base: data center)
2 Edge (distribution base)
10 Archive system
11, 12, 13 File system
20, 21, 22 File storage system
23 File system
24 NIC
30, 31, 32, 33, 34 Client
41, 60 Network
61, 62, 63 Virtual network
101, 201, 301 CPU
102, 202, 302 Memory
103, 203, 303 NIC
104, 204 HBA
105, 205, 305 Disk
110 File transmission and reception function program
112, 312 File system function program
115, 215, 315 Kernel/driver
121 Migration/recall request
211 Archive function program
212 File system function program
213 File sharing function program
214 VLAN function program
221 Archive function
2211 Replication process
2212 Stubbing process
2213 List creation process
22131 Replication list
22132 Stubbing list
2214 Recall process
222 File system function
2221 Priority determination process
2222 File access notification process
2223 Recall request process
223 File sharing function
2231 Access request reception process
224 VLAN function
2241 Priority identification process
2242 VLAN packet transmission and reception process
225 Event notification
226 Recall request
227 File operation/priority
228, 321 Request/response
310 Application
16, 26 Storage system
161, 261 Controller
162, 262 Disk
163, 263 Microprogram
251, 252, 253 Virtual I/F

1. A file storage system having a local file system and connected device coupled to a communication network to which an archive system device having a remotely controlled remote file system is connected and a plurality of client terminals, comprising:
a processor configured to control:
the first communication interface system and the second communication interface system, a file transmission among the file storage device, the archive device, and the client terminals, and
management information regarding a network between the file storage device and the client terminals,
wherein the network is managed as a Virtual Local Area Network (VLAN),
wherein the management information includes an identifier of the VLAN and a priority of the VLAN,
wherein the file includes metadata which include a priority of the file, and
wherein the processor is configured to:
(a) replicate the file in the local file system from the file storage device to the remote file system archive device;
(b) manage the replicated file as a file to be stubbed;
(c) when receiving a write request from the client terminals,
calculate a new priority based on a priority included in a VLAN tag of the write request and a priority of the file, and
update a priority of an accessed file in accordance with the write request and the priority of the VLAN of the management information to the new priority sets a priority information included in the access request as a priority information of metadata for managing the file in the local file system if the access from the client terminal is a first request;
(d) when receiving a read request from the client terminals,
calculate a new priority based on a priority included in a VLAN tag of the read request and a priority of the VLAN, the read request is transferred via the VLAN, and
transfer a result of the read request with the new priority updates the priority information of the metadata based on a result computed from the priority information of metadata of an already stored file and the priority information of the access request if the access from the client terminal is a second request;
(e) retain an access date and time information of the access request;
(f) monitor a used capacity of the file storage device local file system; and
(g) stub files in accordance with an order of the priority of each file stored in the file storage device and information regarding date and time starts a deleting process of a file to be stubbed in the local file system using either the priority information or the date and time information when the used capacity exceeds an upper limit set in advance.

2.-3. (canceled)

4. The file storage device system according to claim 1, wherein
the updated new priority is computed calculated by averaging the priorities used in the calculations priority information of the access request and the priority information in the metadata of the already stored file.

5. The file storage device system according to claim 1, wherein
when the used capacity exceeds the upper limit set in advance, the file to be stubbed in the file storage device local file system is deleted based only on the priority of the file information.

6. The file storage device system according to claim 1, wherein
when the used capacity exceeds the upper limit set in advance, the file to be stubbed in the file storage device local file system is deleted based only on the information regarding date and time.

7. The file storage device system according to claim 1, wherein
when the used capacity exceeds the upper limit set in advance, the file to be stubbed in the file storage device local file system is deleted based on a ratio computed by weighting the priority information and the information regarding date and time differently.

8. The file storage device system according to claim 1, wherein
when the used capacity exceeds the upper limit set in advance, a delete process of the file to be stubbed in the local file system is started based on the priority of the file information or the information regarding date and time, and when the used capacity drops below a lower limit set in advance, the delete process is ended.

9. The file storage device system according to claim 8, wherein
the upper limit of the used capacity set in advance is in the range of 85% to 95% of a total storage capacity of the local file device system.

10. The file storage device system according to claim 8, wherein
the lower limit of the used capacity set in advance is in the range of 75% to 85% of a total storage capacity of the local file device system.

11.-18. (canceled)

19. A non-transitory computer readable medium storing a computer program for execution by a file storage device,
wherein the file storage device is coupled to an archive device and a plurality of client terminals and is configured to store management information regarding a network between the file storage device and the client terminals,
wherein the network is managed as a Virtual Local Area Network (VLAN),
wherein the management information includes an identifier of the VLAN and a priority of the VLAN, and
wherein a file stored in the file storage device includes metadata which include a priority of the file,
the computer program comprising a code causing the file storage device to:
(a) replicate the file from the file storage device to the archive device;
(b) manage the replicated file as a file to be stubbed;
(c) when the file storage device receives a write request from the client terminals,
calculate a new priority based on a priority included in a VLAN tag of the write request and a priority of the file, and
update a priority of an accessed file in accordance with the write request and the priority of the VLAN of the management information to the new priority;
(d) when the file storage device receives a read request from the client terminals,
calculate a new priority based on a priority includes in a VLAN tag of the read request and a priority of the VLAN, the read request is transferred via the VLAN, and
transfer a result of the read request with the new priority;
(e) retain an access date and time information of the access request;
(f) monitor a used capacity of the file storage device; and
(g) stub files in accordance with an order of the priority of each file stored in the file storage device and information regarding date and time when an used capacity exceeds an upper limit set in advance.

20. A method for a file storage device,
wherein the file storage device is coupled to an archive device and a plurality of client terminals and is configured to store management information regarding a network between the file storage device and the client terminals,
wherein the network is managed as a Virtual Local Area Network (VLAN),
wherein the management information includes an identifier of the VLAN and a priority of the VLAN, and
wherein a file stored in the file storage device includes metadata which include a priority of the file,
the method comprising the steps of:
(a) replicating the file from the file storage device to the archive device;
(b) managing the replicated file as a file to be stubbed;
(c) when the file storage device receives a write request from the client terminals,
calculating a new priority based on a priority included in a VLAN tag of the write request and a priority of the file, and
updating a priority of an accessed file in accordance with the write request and the priority of the VLAN of the management information to the new priority;
(d) when the file storage device receives a read request from the client terminals,
calculating a new priority based on a priority included in a VLAN tag of the read request and a priority of the VLAN, the read request is transferred via the VLAN, and
transferring a result of the read request with the new priority;
(e) retaining an access date and time information of the access request;
(f) monitoring a used capacity of the file storage device; and
(g) stubbing files in accordance with an order of the priority of each file stored in the file storage device and information regarding date and time when an used capacity exceeds an upper limit set in advance.
